(19) United States
(12) Patent Application Publication
(10) Pub. No.: US 2007/0060783 A1
(43) Pub. Date: Mar. 15, 2007

(54) Process for the treatment of unwanted toxic, hazardous and infectious leftovers in solid, liquid, gas and radiation form, with different toxic, hazardous and bio-hazardous levels and classifications, generated by various clinics, hospitals and pharmaceutical-biochemical, chemical and to its related industries

(75) Inventor: Harald Walter Kremnitz, Makati City (PH)

Correspondence Address: JONELSON ALBAO CHENG, 1946 BERTRAM STREET, HONOLULU, HI, 96816, US

(73) Assignee: Jon Cheng, Cecil M. Albao

(21) Appl. No.: 11/399,331

(22) Filed: Apr. 7, 2006

Related U.S. Application Data
(60) Provisional application No. 60/669,345, filed on Apr. 8, 2005.

(51) Int. Cl. A62D 3/00

(52) U.S. Cl. 588/313; 210/739; 422/28; 422/30

(57) ABSTRACT

The basic reaction steps in the process during the treatment of toxic & hazardous, infectious, bio-hazardous, metallic and non-metallic residuals and light—slight radiation contaminated leftovers/residuals are: sterilization, remediation, neutralization, oxidation in combination with a three step polymerization, supported through mechanical material destruction mechanism for volume reduction and reagent attachable surface increase. The entire process operates on low temperature and energy, supported through chemical, bio-chemical, physical-chemical and electro-chemical reactions and mechanisms. The whole operation is considered as leftover, emission, odor and discharge free non burn combustion and roasting technology. The process ending is the final conversion and if descried, the homogenization of the formerly unwanted residuals, which are present after the process with an inert like characteristic without the origin of the material can be recognized, into a secondary raw material for further reuse for different products and applications in a human and environmentally safe way.

### 1. FIELD OF THE INVENTION

The present invention relates to an unwanted infectious, bio-hazardous and to this category related leftovers, materials and components conversion and neutralization process. The process is proven/tested of processing such materials and components with its different toxicity and hazardous classifications and operates emission, vapor, odor and residual free. The process is capable of handling all types of waste/leftovers generated out of Dental Clinics, Healthcare Centers, Funeral Parlors, Morgues, Hospitals, Agricultural Test Facilities, Bio-Chemistry-Laboratories, and Pharmaceutical-Biological-Microbiological-Biochemical and to its related Industries. The process can handle leftovers in liquid, solid, paste, powder, fibrous, gas and light radiation form. The leftover material composition generated in general, received and tested are mostly mixtures out of: Blood, Tissues, Body parts, Diapers, Cotton, Textiles resulting from Masks, Coveralls, Bandages, Plastics, Rubber, Dextrose leftovers, Needles, Sharps, Glass, contaminated Blood Containers, Cancer/Tissue Cell Developer Leftovers (Xylene/Benzene and other forms/composition of organic and inorganic components), X-Ray Films, Surgery Waste in general, Batteries, Maintenance Waste, such as leftover Oil, Grease, Paint, Thinner, Solvents, Bleach, etc., expired Medicine and Pharmaceutical Leftovers such as: Fluid's and Drugs, Narcotics, Bio-hazardous Waste in general, Microorganisms/Cultures, Form Cells, Insecticides, Pesticides, Prions (PrP, BSE) Mad Cow Disease and otherwise contaminated Slaughter House Waste, beside infectious and cross contaminated fecal matters/sludge's, septic tank sludge's in general and heavy metal contaminated leftovers/residuals. The process is designed to neutralize, brake apart, rearrange/restructure and convert the incoming materials, regardless of their basic form and chemical composition/nature and the, for those components characteristic and related pH (alkaline, neutral or acidic), such as: organic and/or inorganic based substances, components, parts and any blend thereof, including steel/stainless steel parts blow a diameter of 25 millimeter, by a shredder drive design of 20 (twenty) horse power. Larger/higher horse power ratings will increase the destruction efficiency of the equipment. Based on the previous conducted and continuous ongoing long-term material testing and the corresponding microbiological, biological, chemical and neutralized material physical laboratory analysis, which are conducted under the standards and regulations implemented in the Philippines, the European Union and the United States of America, the said process can be considered as a sterilization and neutralization procedure without immobilizing any form of toxic, hazardous and bio-hazardous matters. The output material present itself in an inert like characteristic and form, without any unpleasant smell and odor, leaching safe, no vapors, earth-dry consistence and heat/fire resistant and completely unrecognizable in relation to its origin. The, during the said neutralization, oxidation and sterilization process utilized additives/reagents in liquid and powder form are freely and widely on the market available and no special permit or licensed chemist are needed for the purchasing, transport, handling and storage of those Reagents. The equipment is designed with its own build in additive blending station for the blending of the final reagent/additive composition.

### 2. DESCRIPTION OF THE RELATED ART

The invention describes a multi-step chemical process technique, with mechanical; chemical-physical and electro-chemical material/waste destruction support, for the treatment of especially infectious and bio-hazardous leftovers/residuals and waste products, using a so called: cold sterilization, neutralization and conversion. The solid material/residuals destruction into small particles decreases the volume of the residuals by roughly 8:1 and increases at the same time the surface through the newly generated small particle sizes, which can be directly/quickly and precise attacked and penetrated from the different additives. The initiation of the different basic process and reaction steps, such as: oxidation, ionization/ozonization, chemical and accelerated bio-chemical remediation, pH swinging-balancing, flocculation, coagulation, soaping effect (soapy characteristic) and 3 step polymerization with medium length and cross liked polymer chains are activated and controlled through adding of the primary additives. The injection of the reagents/additives are a time based step by step procedure, which secure, their destructive behavior of the additives towards the different and under each other mixed up residuals in form of open up/destruct the molecular and particle structures and forces the molecular/particle rearrangement under controlled conditions and reaction sequences. To remain at the same time reactive/counter-reactive between the additives it self and the solid residuals and the maybe additional and pre-neutralized by-blended liquid residuals from the liquid pre-treatment station to perform the final molecular rearrangement, neutralization and pre-homogenization. The main target of the said invention/process technique are the generation of a design for a waste treatment technique/system and equipment for infectious waste disposal, which uses low power consumption, can be build in any size, can be mobile and/or stationary, uses low risk and widely available consumables/additive and can be operated residual, odor, vapor, discharge and emission free. The main criteria addressed with this process invention/innovation is to focus on and secure: a.I. technology with low implementation and operation restriction, to comply and stay in conformity with the new emerged environmental trend of emission and residual free hospital and infectious waste processing; b.II. short fabrication and implementation time; c.III. equipment parts, spare parts including the process consumables need to be widely available on the local markets as standard products; d.IV. easy maintenance of equipment, operator and environmentally safe operation; unrecognizable, reusable, human and environmentally safe secondary raw material output for possible reuse (leftover free); e.V. the multifunctional characteristic of the equipment, regarding the handling and processing of a large variety of leftovers and residuals which can be treated/converted using this process strategy and system.

In comparison to the internationally used and on the market fully implemented medical waste, infectious and bio-hazardous waste disposal technologies, the said invention can present following advantages, as listed and compared to the individual technologies/practice of disposal at the present time: a.1. Incineration and Pyrolisis (thermo-conversion and roasting techniques): The incineration process is at the moment under strong and critical evaluation regarding the emission and the wastewater discharge generated. In several Countries this type of disposal technology are banned or under tide restriction and it is difficult to generate new implementation and operation licenses for such systems. The incinerator, if stationary or mobile are cost intensive and need a long fabrication and implementation time. Several types of, especially pharmaceutical wastes are prohibited for incineration, such as: narcotics (Heroin, LSD, and to this categories related different types of substances in liquid, powder and solid form) and to hospital/clinical operation related radiation containing residuals and heavy metal containing leftovers/residuals; b.2. Autoclave/Steam disinfection: the autoclave process operates very effective, but is time and energy consuming and let show high investment cost. The most of the autoclave/steam disinfection systems using in addition to steam a gas with sterilizing properties and is known under the generic name of Ethylene Oxide and Sodium Hypochorite. This gas is considered a highly toxic and hazardous and creates additional operator/environmental risks. Based on the characteristic of the process technique, the application for disposal and neutralization of infectious wastes are limited, especially by needles and sharps, body parts and the destruction and neutralization of chemical components (especially organic compounds), considered as toxic and hazardous. After the steam disinfection is completed, the disinfected residuals are still recognizable and related to its origin. Therefore those leftovers need to be disposed on a sanitary landfill, which indicated additional cost, human and environmental risk and possible ethical image lost on the generator side. c.3. Microwave: The microwave technology is one of the most common process techniques and operates very effective, and versatile on its design for stationary and mobile application. The investment cost for such equipments are significant and makes the financing and implementation in many Countries very difficult. The operation and material processing cost are reasonable and can be considered average level, compared to the technologies listed under the comparison description a.1. and b.2. The main disadvantage on this process technique is the limitation on the material/residuals input and its processing capability, such as: needles, sharps, metals and heavy metal contaminated leftovers/residuals in general, body parts, waste in liquid and sludge form and the destruction and neutralization of chemical components, considered as toxic and hazardous, especially the mostly in a large amount and variety present and remaining organic compounds and compositions. *Especially: Dialysis, blood filter and chemotherapy waste*.

### 3. SUMMARY OF THE INVENTION

This said process is a multi-relational chemical oxidation process, with an integrated primary chemical and secondary bio-chemical remediation, supported through a 3 step polymerization, which generate a medium length and cross linked polymer chain. The main characteristic of this process is the use of process control chemicals/additives only with the function of initiating the re-structuring/re-arranging the present organic and inorganic substances/matters (particles), generated out of the pre-shredded solid residuals/waste, in combination with liquid residuals, directly added or injected after undergoing a separate pre-treatment, using the same process, only on a separated liquid treatment station, into basic secondary reactive or additive and into bonding and structural components. A main characteristic of this said process is the capability of handling different types of waste/residuals forms, such as: sludge, solids, powder, liquid and fibers together in one treatment step or if needed separate, for example: sludge, solids, powder, oily and grease fluids and fibrous materials are processed over/through the shredding line and the liquid waste/residuals will be pre-neutralized, using the integrated and independent operating liquid treatment station, before injecting the under reaction standing liquid into the blender/mixer. Both processing lines are connected to the ribbon blender/mixer.

A. Preparation of the Process Control Additives/Reagent and Composition/Mixture and Function:

1. Additive composition—liquid form: Hydrogen Peroxide (H₂O₂), industrial grade are diluted into a solution of 5˜50% (five to fifty percent) concentration, preferable concentration of solution 5% (five percent). For the additive dilution the blending station/tank # 2 (FIGS. 1, 3+4−1 blending tank 2) with integrated circulation and medium transfer system (FIGS. 1-2, 12, 13, 14 blending tank 1+2) and discharge lines to the ribbon blender/mixer and from the wet scrubber to the storage tank (FIGS. 1-3) will be utilized. Out of precautionary measures and to increase the operation/operator safety the blending, loading and storage equipment for H₂O₂ are designed as an independent cycle (FIGS. 1, 3+4−1 blending tank 1).The additive H₂O₂ is considered as highly reactive to some of the other additives. After dilution of H₂O₂, a low grade and high diluted Hydrochloric Acid (HCL), with the generic/brand name: muriatic acid of 3% concentration and is regularly sold as household cleaning solution, will be added and agitated into the H₂O₂ Solution. The blending ratio of the diluted H₂O₂ with the diluted muriatic (HCL) acid is between 2-7 volume % (two to seven volume percent), preferred mixture: 3 volume % (three volume percent) of the diluted H₂O₂ volume present. The H₂O₂+HCL are transferred/pumped into a especially marked additive storage tank (FIGS. 1-3) with integrated liquid volume level control (FIGS. 1-4)+(FIGS. 2+2a−10, 11, 12), medium circulation and/or agitation through pump circulation or air bubbling (FIGS. 1-9, 14, 15). The liquid injection amount is measurement and controlled, using a measurement tank with visual level control, which is directly connected to the shredder hopper (FIGS. 2+2a−5, 6) and activated through an injection pump or using the alternative variant of pressurizing the measurement tank with ˜1.5 bar air pressure (as shown in the schematic) to activate and maximize the performance of the multiple placed/mounted injection spray nozzles (FIGS. 2a−2, 10, 11, 12). The by-blending/feeding of said additive into the ribbon blender/mixer can be activated through independent injection pump, or based on the design through air pressure. As shown in the schematic/layout (FIGS. 1−5, 6, 24, 25) and as build and installed in the actual pilot plant (see picture, FIG. Appendix: 2, a-d), the variant of gravitation feeding from the measurement tank to the blender was chosen. The liquid additive feeding to the ribbon blender/mixer (FIGS. 1-5, 6, 20) are centralized activated out of the operator control room. The H₂O₂ is used as oxidizing and radical ion generating agent and will initiate the first basic reactions as follow: I. Destruction of usually present living organism/microorganism/bacteria, none as: Spores, Germs, Spongy, Fungi, Salmonella, Coliform, Yeast Bacteria, Tubercle Bacillus, HIV and other, to the Species of Microorganism related Pathogens and Toxins with aerobic and anaerobic characteristic. One of the mayor Effects are the initiation of the drastically reduction of Proteins, Enzymes, Co-Enzymes and organic Nitrogen, which are the mayor Host for Prions, such as: PrP's, Jacob/Kreuzfeld Disease, Mad Cow Disease (BSE) and other similar/related Parasites. Based on the extensive Research conducted, over the past Years, the Remediation Process let show the same and better effectiveness in comparison with the Incineration Technology on this particular Issue. Proteins, Enzymes and organic Nitrogen Reduction by Remediation 50%, reduction with Incineration Technology (1000 Degrees Celsius) ended up with the same Reduction Factor (see National and International Laboratory Test & Analysis in the Appendix). II. The mixture of industrial grade H₂O₂ and HCL will additionally initiate and directly chemical Attack some of the present organic and inorganic components in form of remediation, oxidation and destruction of molecular structures, especially: on the organic based Parts, Particles and Components present, such as: Blood, Body Parts, Xylene, Toluene, Phenol and Benzene like Substances, Fibers, Tissues and the oxidation and part conversion of present Heavy Metals into metal oxides, metal chlorides and metal nitrates. III. All those reactions takes place in the shredding chamber, in which the solution are injected and react with the under mechanical destruction standing solid residuals. At the same time two different types of gas are injected into the shredding chamber with following generic names, classifications and detailed described on use and function additive/application specific: 1. Ozone (O₃), which is a reversible, instable and oxidizing gas and therefore the ozone gas is produced on the equipment's own ozone generator station. 2. Nitrogen gas (N), the nitrogen gas used is inert and functioning as protective overlay gas about its higher gravity/molecular weight compared to air and ozone.
2. Additive composition—gas form: 1. Ozone (O₃), which is a reversible and oxidizing gas and only 3 to 5 (three to five) minutes stable, before it reverses back into oxygen. Therefore the ozone gas is produced on the equipment's own ozone generator station. Furthermore, the Solution in support with the reversible Gas initiate additionally an Remediation like, increased oxidative Environment as an result of the, to each other corresponding and newly created chemical composition of H₂O₂+O₃+HCL. Ozone is easier soluble in water and hydrogen peroxide then oxygen. Ozone reacts especially destructive to substances such as: Formalin, most of the present Chlorine Components, eliminates odor and smell and is the first of the two components in gas form to prevent the generation of air borne bacteria during the shredding process. 2. Nitrogen gas (N), the nitrogen gas used is inert and functioning as protective overlay gas in combination with the ozone. Nitrogen gas let show the higher gravity/molecular weight then air and ozone and blend with non reactive and passive behavior into the ozone gas. In addition, the nitrogen gas (N) reduces the explosion/dust explosion risk during the entire shredding process. The combination of the injected ozone O₃+N nitrogen gas in addition with the H₂O₂+HCL humid vapors and the linear increasing reaction temperature, generated in an closed environment, additionally initiated and accelerated through to the mechanical force of the rotating shredder head (FIGS. 2+2a−5, 6) during the destruction of the residuals, a gas mixture with high corrosive and oxidative characteristic is generated. This gas vapors activate the side effect of additional oxidation and decomposition by same of the present crystals of metals nitrates, nitrates in general, sulfide and sulfates into their separate gas ions and enforcing the hydration of gas ions, especially by and mostly during the process generated ammoniac-, nitrogen-, chlorine- and methane gases through heat absorption and create the effect of gas molecule destruction through hydration energy and gas condensation.
3. Additive composition—liquid form: Ferric chloride hexahydrate/Iron(3+) chloride hexahydrate (FeCl₃). The Substance FeCl₃ are known under multiple generic names. At the present time, Fe²⁺ is widely used as flocculent by wastewater treatment facilities. A tendency of blending FeCl₃ to Fe²⁺ or using FeCl₃ as single additive is present. FeCl₃ are normally sold in the market as a salt/past like substance with 50% (fifty percent) concentration/industrial grade. The dilution range of FeCl₃ with water for its application as reagent/additive in the said process can be balanced between 5 to 50% (fife to fifty per cent) concentration. The safe and preferred/ideal concentration of FeCl₃ to be used as economical additive/reagent in the said process was evaluated with 7% (seven percent). After dilution of the FeCl₃ substance, forms of diluted sugar and/or polysaccharide with not exceeding 3% (three percent) of its own concentration are blended into the FeCl₃, in a ratio of 5 volume % (five volume percent) of the diluted FeCl₃. The chemical substance of FeCl₃ is considered as a highly corrosive substance, which will react radical and violently with the under step I (one) in the shredder hopper (FIGS. 2+2a−5, 6) injected/placed additives. In relation to the process cost and as precautionary measures, and to maintain the operator and process safety, only low concentrated additives/reagents are used in the said process. After dilution of FeCl₃, a low grade and high diluted form of sugar and/or polysaccharide, with the generic/brand name: sugar, molasses, glycol forms, etc. of 3 % concentration will be added and blended into the FeCl₃ Solution. The preferred blending ratio of diluted FeCl₃ with diluted sugar based molasses substance can range between 2-7% (two to seven percent), preferred mixture: 5% (five percent) of the diluted FeCl₃ volume present. The FeCl₃+C₆H₁₂O₆ are formulated and blended together at the chemical blending station tank # 1 (FIGS. 3-2 blending tank 2) with integrated circulation and medium transfer system (FIGS. 1-2, 12, 13, 14 blending tank 1+2) and discharge lines to the ribbon blender/mixer and from the wet scrubber to the storage tank (FIGS. 1-3) will be utilized. Out of precautionary measures and to increase the operation/operator safety the blending, loading and storage equipment for FeCl₃ and all other additives/reagents are designed as an independent cycle (FIGS. 1-4-1, 2, blending tank 1+2) and physically during storage and handling separated form the additive H₂O₂, which is considered as highly reactive to some of the other additives/reagents used in the process. The FeCl₃+C₆H₁₂O₆ blend are transferred/pumped into a especially marked additive storage tank (FIGS. 1-3, 4) with integrated liquid volume level control (FIGS. 1-3, 4), medium circulation and/or agitation through pump circulation or air bubbling (FIGS. 1+3−9, 14, 15). The liquid injection amount is measurement and controlled, using a measurement tank with visual level monitoring and mechanical (gravitation) overflow control (FIGS. 1+3−5, 6, 24, 25), which is directly connected to the one or more ribbon blender/s or mixer/s (FIGS. 1+2+2a+3−20) and activated through an injection pump or using the alternative variant of pressurizing the measurement tank with ˜1.5 bar air pressure (as shown in the schematic) to activate and maximize the performance of the, in the ribbon blender/mixer, multiple placed/mounted injection spray nozzles, similar as shown under (FIGS. 2a-2, 10, 11, 12). The by blending/feeding of said additive into the ribbon blender/mixer can be activated through independent injection pump, or based on the design through air pressure. As shown in the schematic/layout (FIGS. 1-5, 6, 24, 25) and as build and installed in the actual pilot plant (see picture in the appendix . . . ), the variant of gravitation feeding and overflow control from the measurement tank to the blender was chosen. The liquid additive feeding to the ribbon blender/mixer (FIGS. 1-5, 6, 20) are centralized activated out of the operator control room. The FeCl₃+C₆H₁₂O₆ blend is used as corrosive and oxidizing reacting additive and radical ion generating agent, which will react with the different organic and inorganic substances present in the mechanically destructed residuals and at the same time, radical and violently with the remaining H₂O₂+HCL reagent. This reaction process takes place under controlled conditions in a closed environment at the ribbon blender chamber (FIGS. 1+2+2a−20) and will initiate the second reactions step as follow: I. The destruction process of organic and inorganic components present in the residuals was initiated in the first step at the shredder equipment using mechanical and chemical destruction force. After the shredding process, the particles are feed through gravitation into the in motion standing ribbon blender/mixer (FIGS. 1+2+2a−20) for the second treatment/reaction step. To secure the further elimination of living organism, such as described under “I. Additive composition” and the continuous opening/disconnection of present chemical composition, considered as harmful to human and environment, to generate the basic of a molecular rearrangement, the additive/reagent composed out of FeCl₃+C₆H₁₂O₆ will be added into the under reaction and motion standing, but volume reduced/pre-shredded residuals. II. The main additional chemical reaction characteristics and forms generated are: generation of foregoing reactive hydroxyl radicals (.OH), organic pollution destruction, odor elimination, further destruction of phenols, 15 formalin, formaldehyde, BTEX and similar compositions of it, through the slow adding of the FeCl₃—molasses blend solution, the remaining H₂O₂+HCL—basically H₂O₂ will decompose into oxygen under lower pH (higher as pH 3 and lower as pH 6) conditions, which is given as an result of the mixture and type of additives used. This reaction will generate the, in a later step (upper level pH procedure) needed iron catalysts and will precipitate as Fe (OH)₃. Using the FeCl₃+C₆H₁₂O₆ blend, the expected catalytic cycle, takes place immediately through the presence of H₂O₂+HCL. Based on the long-term observation and testing, FeCl₃ have more advantages on the reaction performance with H₂O₂, compared to Fe²⁺. The in the process preferred and tested sugar additive are: C₆H₁₂O₆.

Figure A: (general reaction overview) based on the in general proven and partial 25 scientifically many times described and elaborated reaction overview in relation of the iron-catalyzed hydrogen peroxide (Fenton's Principe) in using Fe²⁺, which is not so effective in virgin chemical cost, handling, reactivity, versatility on the reaction and reaction speed as the implementation of FeCl₃ for the described process.

General Reaction Overview:
Fe²⁺+H₂O₂→Fe³⁺+OH⁻+OH< >Fe³⁺+H₂O₂→Fe²⁺+OOH+H³⁰,
performed with a pH level of 3.5. III. Basic initiated reaction types and characteristic for the partly completion and pre-preparation of the, to follow processing/reaction steps, to secure a efficient, reconstructive and repeatable molecular destruction and/or rearrangement procedure of the uncountable variety of different organic, inorganic and inert components, at the same time present in such residuals: The first placed additives and chemical group of H₂O₂+HCL+O₃+N and the, during the first processing step accruing cross contaminated with substances and components, elaborated under “A. Preparation . . . function” in combination with the, in the second process step added/injected additive/reagent FeCl₃+C₆H₁₂O₆ blend are following: remediation, oxidation and corrosion, decomposition, which involves organic and inorganic components, catalytically reaction−conversion, generation of ferryl+hydroxyl radicals and free going radical ions and non radical ions and anions in general, oxidative/corrosive damages and destruction of organic nitrogen components, cyanide and potassium composition, fat, oil, grease, proteins, enzymes/co-enzymes and hormones. Additional, major reaction symptom's are the: a. mineralization of different organic based components and; b. through the blending of both additive composition generated first two steps of a three step polymerization and the establishment of the base for the third and final polymerization with cross linked medium and long chain structure/formation, similar to a primitive polymer matrix and; c. significantly utilizing some of the, in the residuals present and during the procedure free going organic components and substances in combination with the additional reagents, added during the following processing steps.

Figure B: (classical reaction example) One of the classical reaction example, chosen out of a variety of controlled, independent and with each other interfering ongoing reaction during the standard procedure of neutralization of unwanted infectious, pathological, medical, pharmaceutical and bacteriological residuals/leftovers in its variations.

Classical reaction example: oxidation of phenol and/or phenol like substances to carbon dioxide and water using hydrogen peroxide. Oxidation is the process of removing electrons and increasing the positive components. One of the ultimate products of complete oxidation reactions are carbon dioxide, water and salts (generation of various crystalline forms, as described earlier). The, to the process related and representative oxidation examples are: Oxidation of phenol to (CO₂) carbon dioxide and (H₂O) water, using (H₂O₂) hydrogen peroxide: C₆H₅OH+14 H₂O₂→6 CO₂+17 H₂O, the basic reaction occurs rapid, when the pH is leveled in to 3˜6 pH and FeCl₃ is used as catalyst. The phenol component is oxidized to CO₂ and H₂O. The hydrogen peroxide (H₂O₂) is educed to (H₂O). Phenol is an organic substance/compound and, because (CO₂) carbon dioxide and (H₂O) water are the end products of this reaction, the *mineralization* of the phenol has occurred. IV. This reaction advantage of crystallization/mineralization of organic and inorganic components in combination with the generation of metal oxides and metal nitrates, is the basic to accomplish the structural fundament of the creation of *zero dimensional crystals*. The process of crystal generation is supported through the, to this process type characteristic exothermic reaction. In addition, during the ongoing and process specific chemical component destruction/remediation and the later in the process implemented homogenization, the necessary physical-mechanical pressure on the material pressure on the material is achieved. The density and strength of zero dimensional crystals, with their irregular molecular structure/characteristic generates itself in the right condition through using an alien particle as base/host (Principle of the hail stone forming), which is in this case mostly metal oxides or metal nitrates/oxidized metal nitrates. The formula and basic guideline of the crystal generation, form and strength following: with in crease of every 10 Degrees Celsius the temperature rises over the basic temperature of 35 Degrees Celsius and the addition of pressure, considered with every 800˜1,000 Kilogram pressure increase, the molecular strength of the zero dimensional crystals will multiply by 10². One of the main concerns of the invention is the generation of a chemical/physical multifunctional environment during the whole process to secure, based on the uncontrollable variety of substances and components/compounds, which are controlled and guided in their reaction and behavior through the especially created process additives/reagents/mixtures and its feeding sequence/procedure, to guarantee different and from each other independent, but sequence related reactions can occur and performing undisturbed without limiting the output quality of the processed, converted and neutralized material.
4. Additive composition—liquid form: Aluminum Sulfate: Al₂(SO₄)₃ also useable if blended with (Al₂ O₃). The Substance of Al₂(SO₄)₃ are known under multiple generic names, such as: Alum, Cake Alum and Sulfate variations of it. At the present time, Al₂(SO₄)₃ is widely used as flocculent by wastewater treatment facilities and to make textiles and fibrous material fire resistant. Al₂(SO₄)₃ is very easily soluble in water, let show the pH range on the acidic side (pH 2.5 by 5% solution) and slow soluble in alcohol. The industrial grade/concentration of Al₂(SO₄)₃ sold on the market are over 90% (ninety percent) and the basic chemical is in salt form. The dilution range of Al₂(SO₄)₃ with water for its application as reagent/additive in the said process can be balanced between 1.5 to 50% (one point five to fifty per cent) concentration. The safe and preferred/ideal concentration of Al₂(SO₄)₃ to be used as economical buyable additive/reagent in the said process was evaluated with 5% (five percent). After dilution of the Al₂(SO₄)₃ substance, forms of diluted alcohol, preferred and tested: standard rubbing alcohol C₃H₇OH, which result in Al₂(SO₄)₃+C₃H₇OH, and/or polyalcohol with not exceeding 5% (five percent) of its own concentration are blended with the Al₂(SO₄)₃ together, using a ratio of 5 volume % (five volume percent) of the diluted Al₂(SO₄)₃. The basic use and function of Al₂(SO₄)₃+(C₃H₇OH) in the entire process reaction chain as follows: a. The chemical substance of Al₂(SO₄)₃+(C₃H₇OH) is considered as oxidative/corrosive substance and functioning in the process as coagulant, flocculent and disinfectant, like all other additives and reagent used in the process before. b. To control, direct and redirect the different ongoing chemical reactions and the factor pH, which need to be observed and maintained. The process start is made by a low pH level (pH 2.0 to 3.0), in depending on the composition of the residuals added. After the first basic reactions starting, influenced through the additives added and the physical-mechanical impact, more control additives, described under section “3. Additive composition” are added and based on the pH of the additive and the ongoing reactions the pH level in general will increase up to pH 6.0 to pH 7.5. For same ongoing and previous described reaction the pH level has to be dropped of pH 2.0 to pH 3.0 and will be newly increased/balanced at a later processing step. Therefore, Al₂(SO₄)₃+alcohol blend functioning also as one of the pH swinging/changing additive in the process, without causing any uncontrolled, violent and radical reaction forms. c. The, in the first reaction step unused/remaining parts of Al₂(SO₄)₃+C₃H₇OH blend, are essential for the following processing step, which is the adding of a caustic soda solution (sodium hydroxide). Both additives/reagents will react in combination, with same of the pre-rearranged components/compounds of the formerly placed residuals. This reaction combination will be the final stage for the formation of the zero dimensional crystals, the particle crystallization effect in general and the generation of zeolite like structures. Based on our empirical testing procedures and reaction observations conducted, following finding was made: a certain amount of the generated crystal and zeolite like formations where implemented and/or immobilized as binding and chain connecting component in the cross linked, molecular chain configuration, which will generate on a later step the final, but low grade, polymer matrix like structure. The Al₂(SO₄)₃+C₃H₇OH blend are formulated and blended together at the chemical blending station tank # 1 (FIGS. 3-2 blending tank 2) with integrated circulation and medium transfer system (FIGS. 1-2, 12, 13, 14 blending tank 1+2) and discharge lines to the ribbon blender/mixer and from the wet scrubber to the storage tank (FIGS. 1-3) will be utilized. Out of precautionary measures and to increase the operation/operator safety the blending, loading and storage equipment for Al₂(SO₄)₃+alcohol blend like by all other additives/reagents are designed as an independent cycle (FIGS. 1+3−1, 2, blending tank 1+2) and physically during storage and handling separated form the additive H₂O₂, which is considered as highly reactive to some of the other additives/reagents used in the process. The Al₂(SO₄)₃+C₃H₇OH blend is transferred/pumped into an especially marked additive storage tank (FIGS. 1-3, 4) with integrated liquid volume level control (FIGS. 1-3, 4), medium circulation and/or agitation through pump circulation or air bubbling (FIGS. 1+3−9, 14, 15). The liquid injection amount is measured and controlled, using a measurement tank with visual level monitoring and mechanical (gravitation) overflow control (FIGS. 1+3−5, 6, 24, 25), which is directly connected to one or more ribbon blender/s or mixer/s (FIGS. 1+2+2a+3−20) and activated through an injection pump or using the alternative variant of pressurizing the measurement tank with ˜1.5 bar air pressure (as shown in the schematic) to activate and maximize the performance of the, in the ribbon blender/mixer, multiple placed/mounted injection spray nozzles, similar as shown under (FIGS. 2a-2, 10, 11, 12). The by-blending/feeding of said additive into the ribbon blender can be activated through independent injection pump, or based on the design through air pressure. As shown in the schematic/layout (FIGS. 1-5, 6, 24, 25) and as build and installed in the actual pilot plant (see picture, FIG. Appendix 2, a-d), the variant of gravitation feeding and overflow control from the measurement tank to the blender was chosen. The liquid additive feeding to the ribbon blender/mixer (FIGS. 1-5, 6, 20) are centralized activated out of the operator control room.
5. Additive composition—liquid form: Sodium Hydroxide (NaOH). The Substance NaOH are known under multiple generic names, such as: Natrium Hydroxide and Caustic Soda, which is the most common name in the industry. The substance, even high diluted, will stay highly corrosive. At the present time, NaOH is used as flocculent by wastewater treatment facilities, cleaning agent for equipments to crack oily and greasy substances, as bleaching agent, additive for disinfectants, electroplating industry, etc. NaOH is soluble in water and react in contact with H₂O strong exothermic, let show the pH range on the alkaline side (pH 12˜14). The industrial grade/concentration of NaOH sold on the market ranges over 75% (seventy five percent) purity and the basic chemical is in salt/powder, pellets or lump form. The dilution range of NaOH with water for its application as reagent/additive in the said process can be balanced between 2 to 50% (two to fifty per cent) concentration. The safe and preferred/ideal concentration of NaOH to be used as economical buyable additive/reagent in the said process were evaluated with 7% (seven percent). During the dilution procedure of NaOH with water, special attention to the rapid increasing exothermic reaction has to be given and to secure, before the start of the blending procedure, all needed precautionary measures are in place. Use the MSDS—Material Safety Data Sheet—of the Substance as guideline. The diluted additive/reagent NaOH will end the basic and main chemical processing steps through initiating following reaction combinations on its own : a. The NaOH is considered as oxidative/corrosive substance and functioning in the process as coagulant, flocculent and disinfectant, like all other additives and reagent used in the process before. b. To end and combine different ongoing chemical reactions and lift up and balance the pH factor. The start up of the process was made with a low pH level (pH 2.0 to 3.0), which is always depending on the composition of the residuals added. As explained before, after the first basic reactions starting, influenced through the additives added and the physical-mechanical impact, more control additives, described under section “3. Additive composition” are added and based on the pH of the additive and the ongoing reactions the pH level in general will increase up to pH 6.0 to pH 7.5. For same ongoing and previous described reaction the pH level has to be dropped of pH 2.0 to pH 3.0 and will be newly increased and balanced, using NaOH as pH leveling additive. The final pH of the material will be placed on a pH level of pH 8.0. Therefore, the NaOH solution influence the pH swinging/changing in the process in the opposite direction, without causing any uncontrolled, violent and radical reaction forms, which is also due to the very weak additive/reagent concentration used in the process. c. The NaOH solution is very reactive and destructive to any remaining component of organic acids. d. The, in the previous reaction step unused and remaining parts of Al₂(SO₄)₃+C₃H₇OH blend will react now with the added NaOH and in combination with same organic, but primarily with inorganic leftover substances, compounds or components/particles and in the meantime attached to the Al₂(SO₄)₃+C₃H₇OH blend or still free standing. This reaction combination will be the final stage for the formation of the zero dimensional crystals, the particle crystallization effect in general and the generation of zeolite like structures. e. The solution of NaOH will eliminate/oxidize additionally the, during the ongoing process reaction earlier in small amount generated carbon dioxide (CO₂). The NaOH solution react with CO₂ the following:
   CO₂(g)+H₂O (1)⇄H₂CO₃ (ag) 1
   H₂CO₃(ag)+NaOH (ag)→NaCO₃(ag)+H₂O (1) 2
   The virgin NaOH will be diluted with water at the chemical blending station tank # 1 (FIGS. 3-2 blending tank 2) with integrated circulation and medium transfer system (FIGS. 1-2, 12, 13, 14 blending tank 1+2) and discharge lines to the ribbon blender/mixer and from the wet scrubber to the storage tank (FIGS. 1-3) will be utilized. Out of precautionary precautionary measures and to increase the operation/operator safety the blending, loading and storage equipment for NaOH is like by all other additives/reagents designed as an independent cycle (FIGS. 1+3−1, 2, blending tank 1+2) and physically during storage and handling separated from the additive H₂O₂, which is considered as highly reactive to some of the other additives/reagents used in the process. The Al₂(SO₄)₃+alcohol blend are transferred/pumped into an especially marked additive storage tank (FIGS. 1-3, 4) with integrated liquid volume level control (FIGS. 1-3, 4), medium circulation and/or agitation through pump circulation or air bubbling (FIGS. 1+3−9, 14, 15). The liquid injection amount is measured and controlled, using a measurement tank with visual level monitoring and mechanical (gravitation) overflow control (FIGS. 1+3−5, 6, 24, 25), which is directly connected to one or more ribbon blender/s or mixer/s (FIGS. 1+2+2a+3−20) and activated through an injection pump or using the alternative variant of pressurizing the measurement tank with ˜1.5 bar air pressure (as shown in the schematic) to activate and maximize the performance of the, in the ribbon blender/mixer, multiple placed/mounted injection spray nozzles, similar as shown under (FIGS. 2a-2, 10, 11, 12). The by-blending/feeding of said additive into the ribbon blender/mixer can be activated through independent injection pump, or based on the design through air pressure. As shown in the schematic/layout (FIGS. 1-5, 6, 24, 25) and as build and installed in the actual pilot plant (pictures, figure appendix: 2), the variant of gravitation feeding and overflow control from the measurement tank to the blender was chosen. The liquid additive feeding to the ribbon blender/mixer (FIGS. 1-5, 6, 20) are centralized activated out of the operator control room.
   Preparation of the Secondary Raw Material for Homogenization:

After the additives in liquid and gas form are added and the mixing/blending time, preferred, of 15 (fifteen) minutes in the ribbon blender/mixer (FIGS. 2+2a+3+3a−20, 20a) is accomplished, the first dry chemical/additive will be blended into the pre-neutralized and sterilized mixture. The general mixing time are depending on the concentration of the additives used. By a low additive/reagent concentration a longer mixing/blending time (chemical contact time/reaction time) is needed, compared to the use of stronger/higher concentrations of the additives, shorter reaction/contact time needed. Attention: stronger/higher additive concentration will result in higher temperature, more gas and vapor generation, which has to be absorbed by the wet scrubber, shorter reaction—blending/mixing time. The, in the documentation stated operation time frames are based and related to the before mentioned additive/reagents concentration and also used in the test operation of the pilot unit, to develop, evaluate and prove the function of the said process method.
6. Additive composition—dry powder form: Pulverized Lime Stone (Ca) and or Hydrated Lime (CaO) industrial grade with a pH range between pH 7.5 to pH 12.4 can be used, or a mixture of it. The Ca and/or CaO are loaded into the equipment, using a dust sealed pocket elevator, or any suitable conveying system, direct connected to the storage silo/tank (FIGS. 2+2a+3+3a−4, 4a). From there the Ca and/or CaO are transported over a second conveying system (FIGS. 2+2a+3−14) to the in motion/rotation standing ribbon blender/mixer (FIGS. 2+2a+3+3a−20, 20a). The amount of Ca and/or CaO to be placed can be controlled through weight indicator or using an electrical control-timer. After the Ca and/or CaO are placed into the ribbon blender/mixer, additional mixing time of 5 (five) minutes has to be conducted, before the final binder will be placed. The powder additive Ca and/or CaO will function as partly drying agent and stop the still ongoing chemical reactions of the previous placed additives/reagents. At the same time, Ca and/or CaO balances and solidify the generated/simulated low grade polymer matrix and the material present itself in a slide/small pellet like characteristic. The amount of Ca and/or CaO placed into the mixture is calculated with 10 volume % (ten volume percent) of the total volume of treated material present in the ribbon blender/mixer (FIGS. 2+2a+3+3a−20, 20a). Out of the attached and described layout drawings can be seen, the implementation of a more ribbon blender/mixer system is advisable to change the batch by batch process characteristic into a continuous process flow. The Ca and/or CaO additive takes over several, but not direct to the process outcome important chemical reaction, especially if low grade and pure Lime Stone (Ca) is used in the process. The most of the reactions are related to the remaining nitrate and sulfide compounds. Based on our experience, if Hydrated Lime (CaO) is used in single/pure form or blended with the volume percent need to be changed, as follow: a1. pure, low grade Lime Stone (Ca) is calculated with 10 volume % (ten volume percent) of the total volume of treated material present in the ribbon blender/mixer. b2. for the process ideal mixture is: pure, low grade Lime Stone (Ca), mixed with 20 volume % (twenty volume percent) of the lime stone volume, with Hydrated Lime (CaO) and blended with a calculated amount of 8 volume % (eight volume percent) of the total volume of treated material present in the ribbon blender/mixer. c3. Variant of industrial grade Hydrated Lime (CaO) as single additive with as pH of normally ˜pH 12.4 can be added with calculated amount of 5 volume % (five volume percent) of the total volume of treated material present in the ribbon blender/mixer. Result: beside the lower amount of additive involved, the cost factor will increase 2.5 times based on the market evaluation, compared to the use of Lime Stone (Ca). Conclusion: the mixture, as described, of Ca and/or CaO is preferred and the most feasible, if all positive side effects are considered. The different additional reaction, called “additional side effects” are not described in detail, the functions are considered as common knowledge and widely known.
7. Additive composition—dry powder form: Cement of the types: Pozzoland or Portland industrial grade with his standard pH range can be used, or a mixture of it, to increase the cost efficiency. The binder it self can be any time reformulated and replaced with any similar and in the industry used binding material for such applications, such as: Bentonite, Grout, Adhesives, or mixtures of it. The preferred and most economical for the said process are the Cement binder. The Cement binder are loaded into the equipment, using the same dust sealed bucket elevator, or any suitable conveying system, as by lime stone, which is direct connected to the storage silo/tank (FIGS. 2+2a+3+3a−4, 4a). From there the Ca and/or CaO are transported over the same second conveying system (FIGS. 2+2a+3−14) to the, in motion/rotation standing ribbon blender/mixer (FIGS. 2+2a+3+3a−20, 20a), as described by lime stone. The estimated amount of Cement to be placed can be controlled through weight indicator or using an electrical control-timer. After the Cement are placed into the ribbon blender/mixer, additional mixing time of 10 (ten) minutes has to be conducted. At this stage, the possibility of blending any other type of additional additives, such as: plasticizer, water repellent agent, coloring pigments, etc. to the final binder. The powder additive Cement will function as partly drying and final binding agent. The amount of Cement and additional product additives are based on the desired, later use of the neutralized and sterilized secondary raw material. To produce standard cubical blocks for use in secondary applications, or for safe disposal in the landfill, the mixture is calculated with 0.8 Kilogram (zero point eight Kilograms), per 20 Kilogram (twenty Kilograms) of treated material present in the ribbon blender/mixer (FIGS. 2+2a+3+3a−20, 20a). The amount of Cement blended/added and which additional, product related additives are used with the treated material will be always product specific. Based on our tests, any product which has to be formed, molded (pre-cast concrete like procedure) or in paste consistency can be produced out of the new generated secondary raw material. Out of human ethical matters, only products with secondary application, such as: landscaping- and interlocking embankment protection elements, fencing panels, sidewalk paving and other, to this field of application related products should be produced. To prove the material durability, following product types where fabricated: Hollow Blocks, water based decor plaster with acid resistant and coloration stable qualities, mineral soil layer for landfill application, concrete pipes and channels, interlocking element and block systems, etc. These products are implemented to evaluate their behavior under normal environmental influences and conditions. The main purpose of evaluation: visual control of physical performance, no regeneration of molds and other non-beneficial microbial cultures growth, possible re-growth of beneficial algae and moss by products used in landscape application, fire resistance and no generation of toxic and hazardous vapors generated be long-term contact with heat and acidic substances, human acceptance of material appearance. All this tests and evaluation are proven in form of picture documentation and laboratory test results and analysis, regarding the human and environmental safety and the product performance, related to their physical evaluation and performance.(results and documents see at the FIG.: Appendix 1.+2.). The Cement additive takes over none, to the process direct related and important chemical reaction. The only function of the Cement binder are the strong binding of the material particles during the molding, cast, extrusion and/or homogenization process, to generate a stable, durable and dense material bond/structure. From the chemical reaction side, the Cement additive/reagent guarantees, after the drying/curing time the pH level. The different additional reaction initiated and performed by and through the Cement additive, what we calling: “additional side effects” are not described in detail; the functions are considered as common knowledge and widely known, used and described. Binder Variant and Option: A very suitable replacement of the Cement binder are the homogenization, using polymer based binders to generate a very stable and dens molecular—short or long chain linear or cross linked polymer matrix. The fundament for a simulated/low grade polymer structure are partly generated through the reagents/additives used in the neutralization, sterilization and conversion process characteristic. All needed components in direction polymer matrix are implemented in a form, which allow the use/application of low grade polymer components for such undertaking. Using polymers for homogenization and final binder, the process cost will be increased by a calculated 35% (thirty five percent). The procedure and base formula to generate a stable and low cost polymer matrix to homogenize such pre-treated residuals are listed under the write up of: HANDLING and NEUTRALIZATION of light RADIATION WASTE.
   Handling and Neutralization of Light Radiation Waste:

One very special group of residuals is generated at the hospitals, clinics, dental clinics, laboratories and in the pharmaceutical industry, which is out all ranges, of normal waste disposal norms are the residuals of: radiation therapy, radiology waste-x-rays (isotopes and films), radiation liquids (intravenous radiographic contrast), related to scanner/scanning procedure, etc. The radiation classifications are mostly and evaluated: x-ray radiation and gamma radiation gamma rays) on low level. Physical-chemical background: x-rays and gamma rays are energy transmitted in a wave without the movement of any material. X-rays and gamma rays are different in their origin. X-rays are emitted by an electrical devise. Gamma rays are produced by unstable or radioactive isotopes. In some cases, the radiations are remaining in materials which they are penetrated in form of contact contamination, or remain as unwanted contamination in a former important and beneficial substance, such as: injection fluid for scanner and remains resulting out of the radiation therapy, etc. The remaining radiation, especially materials and substances contaminated/containing those types of radiation let show a short half-life time. Of measuring the present and remaining radiation, including the half-life time reduction/radiation reduction efficiency time frame, in the said process used, are based on the American Standard=European Standard: milliGrays (mGy) and/or microGrays (μGy). The other measurement scale is: sieverts, but not applicable for that application. The comparison level of radiation contamination and Standard of allowance is milk. The allowable radiation concentration of milk is very precise and strict internationally regulated and therefore the best reference guideline. All radiation tests are conducted in the radiation laboratory/radiation institute of the University of the Philippines. Pre-tests for several different applications, beside radiation level reduction/elimination and several others, to the process related adjustment are made in the Swiss radiation laboratory UFAG in Zurich and the Louis Pasteur Laboratory in Strasbourg, France (see results of laboratory analysis in the appendix).

Safety Mode & Procedure to Neutralize Light Radiation Waste:

1. Step of Procedure: The radiation contaminated waste has to be separately collected in especially for this purpose designed containers and properly marked. The labels should include, beside the markings, based on the national and international regulations, also a kind of Material Safety Data Sheet (MSDS), which indicates the type, the material contaminated, and concentration of radiation. The personnel for the collection, handling, transport, and storage of such materials, has to undergo a special training in instruction program, which includes also the emergency response and the use of the proper protection equipment and gadgets.
2. Step of Procedure and neutralization Process entry: The stationary treatment stations have integrated and mobile equipments/units will have optional/additional, smaller installation integrated to handle, treat and accommodate in general such type of residual/waste conversion. SAFETY: The radiation contaminated and/or similar leftovers/residuals need to be handled, transported and treated separate and independent from all other residuals and leftovers, to reduce and eliminate operator risk and prevent any cross contamination with any regular infectious/bio-hazardous waste. The amount of described leftover/residuals are very small and therefore the treatment installation are not space consuming. The handling, operation, and processing sequences are identical to the normal leftover/residual processing procedure. The additives/reagents are used for this process are the same, except one additional mixture has to be added into the material for neutralization. The binder and final process procedure are different from the normal/standard operation. The materials are placed into the shredding system (FIGS. 2+2a+3+3a−5, 6). Through the, under (FIGS. 2-9, 10, 11, 12) shown, *theoretical third* independent additive/reagent mixing/blending station (FIGS. 2-12) and pressurized additive measurement tank (FIGS. 2-10, 11), which is directly connected to the shredder injection/spray lines (FIGS. 2-9) the additional solution for the said neutralization process will be prepared and injected. Variant: Residuals in powder and liquid form can be pre-neutralized directly in the blending station, and separately collected for further treatment, in form of blending/injecting the liquid portion to the shredded, surface increased and fibrous, pre-neutralized solid portion in a ration of 1:1 of the theoretical/estimated weight (not volume) +−10% (+− ten percent) tolerance.
3. Step of Procedure—neutralization Additives/Reagents used and their function: The substances and pre-blended solution for the pre-neutralization are equal to the preferred concentrations and mixtures, used in the main process. The additives/reagents in solution form can be taken directly out of the additives/reagents storage tanks and blended in following sequence and concentration/volume into the radiation contaminated and for the pre-neutralization process prepared leftovers. H₂O₂+HCL, or+diluted muriatic acid=low grade HCL acid will be added to the blending tank (FIGS. 2-12) and/or continuously injected (FIGS. 2-9, 10, 11, 12) into the shredder hopper during the shedding/material destruction and deformation process (FIGS. 2+2a+3+3a−5, 6).

The amount of additives/reagents added in total is based on the weight of the residuals/leftovers input—not on the volume. The weight calculation for additives/reagents is: 1 Ltr. (one liter) of additives/reagents can be converted into 1.2 Kilogram (one point two Kilogram) of weight. The weight of the residuals/leftovers are given through the material receive and input monitoring (materials are scaled and weight on receiving). Additive and Residuals blending/material balance Example: Of 1 Kg (one Kilogram) of said residuals/leftovers, 0.2 Kg=20 dkg=200 g (two hundred gram) of total additives has to be added/blended into. The additive/reagent blending sequence are equal to the main process procedure, except one additional and especially for those process and material type generate additive/reagent will be implemented/added. Also the, for the treated material suitable binding, structuring and homogenization components are different from the main process procedure, but can be used any time in the main process too, as stated and described before.
Additional Additive/Reagent and its mixture and function: Radiations are waves and generated through different sources, which are: Wave and Frequency generator, natural occurring/earth radiations/magnetic fields and resulting out this, every metal (iridium, cobalt, uranium, californium, plutonium, etc.), matter and element have his own wave/frequency characteristic in different forms of wave length, density and type (as: alpha, beta, gamma, etc.). Basic groups of radiation wave and its determination: a. natural occurring radiation and b. artificial/manmade radiation waves. To shorten the radiation half-life time and therefore to reduce and eliminate the radiation potential of contaminated residuals, the said process introduces the use of counter waves, also generated from metals and metal based substances. These metal based substances are: Aluminum Sulfate, Cupper Sulfate, Magnesium Sulfate and Iodine Solution (tincture) as metal sulfate group and Ferric oxide, Cupper oxide, Magnesium oxide from the metal oxide group. During the, for the main process characteristic, metal leaching, separation, liquefying and the conversion of those in the residuals present and free coming metals into metal nitrates and metal oxides, will be also the basic procedure for the radiation contaminated residuals in the first processing step. To accomplish the first processing step, the standard additives/reagents out of the main process are used and blended with the additional additive/reagent group, which is a mixture of different metal-based sulfates, and will react in combination with the main additives in a jointly initiated metal leaching/liquefying/oxidizing reaction.
   A. Formulation and Blending Procedure of the Second and Additional Additive/Reagent are as Follows:
Metal based mixture out of: I₂+Cu₂SO₄+MgSO₄7 (H₂O)+MgO+Fe₂O₃+Cu₂O.
Blending recipe sulfates: The entire above listed sulfate substances can be blended together with the same volume amount=equal parts in diluted form. The dilution factor of the sulfates is: concentration after dilution 5% to 50% (five to fifty percent), preferred dilution calculated and tested with 10% (ten percent).
Blending recipe oxides: The entire above listed metal oxide substances can be blended together with the same volume amount=equal parts in concentrated form and blended with the mixture prepared as described under position *A.* The total amount of the pre-mixed oxides added to the pre-mixed sulfated should not be under 3 volume % (three volume percent) of the volume of the sulfates and not exceed 20 volume % (twenty volume percent) of the total sulfate solution volume. Preferred blending volume of metal oxide to the metal sulfate solution are calculated and tested with 7 volume % (seven volume percent).
Remark: Those metals are used to generate also the needed exchange and generation of, and between ions and cations. The metal substances used forming cations with +1, +2 and more than +2 charges. The ion/anion/cation exchange is one of the essential chemical/electro-chemical/chemical-physical reactions in the said process, beside the final polymerization of the finished material in form of a high density homogenization, using a cross linked polymer matrix.
   B. Total Formulation of Main Additives used in the Standard Process:
Main additive/reagent mixture for pre-preparation and neutralization of regular infectious, bio-hazardous residuals/leftovers described and listed before, as follows:
   H₂O₂+O₃+HCL+N+FeCl₃+C₆H₁₂O₆+Al₂ (SO₄)₃+(C₃H₇OH)+NaOH.
Summary: The under A.+B. listed substances and its common known reaction and application characteristic let show we generate/initiate during the different process steps, beside a wide range of counter waves also a metal leaching/liquefying, organic component/compound destruction/remediation and oxidation, the basic for a low grade polymer matrix in combination with the recovered and implemented classic component, generated during the neutralization process out of the infectious and bio-hazardous leftovers/residual for disposal.
   4. Step of Procedure—Additives/Reagents Blending/Mixing:
After the adding of the additives out of the before described group A.+B. over the injection systems (FIGS. 2-9, 10, 11, 12) to the shredder hopper system (FIGS. 2+2a+3+3a−5, 6) and ribbon blender/mixer (FIGS. 1+2+2a+3+3a−20), in which the destructed and in volume decreased, but in their chemical attackable surface increased leftovers/residual are generated and/or placed, a mixing/contact time of preferred 20 (twenty) minutes of blending is needed before the final polymer binder/components are added. The pH of the material after the mixing time should be balanced of the preferred pH 8.0 up to pH 10.0. If the pH level is lower, the polymerization and the polymer chain creation are not in the needed quality and strength. The low pH level influence also the reaction speed and the material after curing time can be brittle and very instable. A higher pH level during the polymerization process let show, based on the empirical tests conducted, no negative impact on the polymer structure and material density and performance in general.
Chemical and physical Accomplishment; towards radiation contamination/half-life time reduction/elimination:

The chemical remediation, the material (solids) surface increase and the liquefying of metal substances in the remaining contaminated residuals and the same effect generated by the used virgin additives increases the free movement of the molecular structures/elements in form of ion exchange, cation generation and free going radicals under strong oxidative conditions by continuous changing pH level and the process will end in the final stage of the procedure with a higher (alkaline) pH level to support the creation of a stable polymer matrix. The main accomplishment of this process step is the opening and the generation free movement and the optimal blending of the metal molecules with its own different radiation—wave length and forms under each other. If those different molecules, with their variation of wave length formations, are blended well under each other and through implementing a strong and tight polymer matrix and exposed to high pressure, the different wave forms will function as counter waves, which results in a significant disturbance with each other and eliminate the free wave expansion and generate a type of a shortage between the waves. Those reaction will easily recognized on the unusual high temperature generated, which is not only and common result of the ongoing chemical reaction of the additives/reagent with each other and the, from it attacked residuals, in combination with the normal generated temperature increase during the forming process of the polymer matrix. In assumption and under normal conditions, the experience let show; the temperature generated can be measured with 40 to 63 (forty to sixty) Degrees Celsius. Using the neutralization process with slide radiation contaminated residuals and the implementation of the additives, suitable and decided for the counter wave generation the material/reaction temperature will exceed 85 to 100 (eighty five to one hundred) and over Degrees Celsius. The reaction temperature of the different process procedures (with light radiation contamination and without radiation contamination) was measured if the material was under pressurized conditions and the polymer matrix forming was accomplished. After 5 (five) minutes reaction time and releasing the pressure and de-forming/molding the material in plate form a curing time of 30 (thirty) minutes was imposed, before measuring the remaining radiation level with a radiation scanner, normally used in the food and processing industry and the customs for radiation level control and quick radiation checks. The laboratory analysis let show after 30 minutes to one hour the radiation level dropped over 98.30%. (see FIG. Appendix: 1. Laboratory test results—Philippine Nuclear Research Institute and FIG. 7—Counter Wave).
Process Conclusion, Findings and Explanation: The basic assumption of both described and over a long period of time in practice/practical operation, tested process variants, which are specific in its own application, but for the some main process, let show: There are too many possible chemical reaction variations on the first hand generated from the incoming leftovers/residuals. Those leftovers/residuals are from batch to batch different in its combination/composition, even if the leftovers/residuals are generated by the same source. The only constant factor to calculate with, are the basic additive/reagent formulation, which are used in this case only as reaction initiating and reaction process control additives/reagents. To establish a repeatable chemical-chemical-physical and electrochemical reaction formula is nearly impossible. Therefore the main/said process was undergoing over years practical/on site test operations, beginning from beaker test up to a complete pilot operation to secure and prove, through a whole range of empirical tests the theory/invention. All tests were made in combination/cooperation with the corresponding and accredited laboratories under implementation of the national and international standards and regulations for such types of leftovers/residuals and its disposal regulations. The process/system/technology evaluation target, beside the proof of function was: public acceptance, equipment durability, operator and process safety, emission, odor, discharge and leftover free non-burn process for the generation of unrecognizable, reusable and human and environmental safe secondary raw material. Therefore the process relies mostly on empirical tests and corresponding laboratory analysis's to prove the performance of the theoretical assumptions out of the fields of: mechanics, safety, process logistic and strategy, feasibility, acceptance in general, durability, chemical and physical reaction.
   Best Mode and Procedure to Generate the Described Polymer Matrix:

The generation/production of a polymer matrix are basically known and applied daily in the industry. For the application in the said and described process, the standard polymerization techniques to establish a polymer matrix can be used in general, which is a mixture of Isocyanate and Polyole and through adding of Ammonium Chloride the reaction speed can be made variable, including the reaction gas generation and its expansion. As replacement, through the used of additional pressure and heat, different types of resins will fulfill the same function and purpose. But all those matrix generating possibilities have two negative sides, in relation to the said and described process, which are: a. the reaction speed is too quickly and difficult to control and b. mostly is the additive cost factor, including the especially prepared equipment cost to implement those types of techniques to expensive and will make the process feasibility questionable.

The procedure to establish a polymer matrix, without jeopardizing the feasibility of the said process and be able to used the installed standard equipments, the polymer matrix has to be generated out of the following additives and mixtures there of: Step a. One of the basic and widely known components is needed, which is Poleole. Step b. Is the preparation of a basic mixture, which is a combination of water, sugar and household grade rubbing alcohol. This mixture/blend will eliminate the use of Isocyanate and Ammonium Chloride, used as the chemical reaction and expansion timer.
Blending Recipe and Procedure: Using for the Isocyanate replacement following additives/reagents: 600 ml (six hundred ml) of normal tap water (H₂O)+500 g (five hundred gram) of low grade sugar (C₆H₁₂O₆)+300 ml (three hundred ml) rubbing alcohol (C₃H₇OH) household quality. This mixture are considered as the Component A and the Polyole as Component B. Both additives/components are blended in the equal amount with each other and mixed in a ratio of 0.70 (point seven) liter A+0.70 (point seven) Liter of B to an amount of 15 (fifteen) Kilogram of the pre-neutralized residuals. This mentioned mixture is the preferred blending procedure. The amount can be any time increased or lowered, but not below 0.35 (point thirty five) Liter of each components (A+B), based on the needs and application. The optimal/preferred blending/contact time between the additives (A+B) and the pre-neutralized leftovers ranges by 5 (five) minutes. The amount of pressure applied on the material, after pouring it in a variable shape mold/form should indicate minimum 1,500 (one thousand five hundred) Pound per Square Inch (PSI), the preferred pressure are 2,500 (two thousand five hundred) PSI. During those ongoing reaction, the basically pre-prepared low grade polymer structure will be implemented and support the, mostly medium to long, cross linked polymer chain formation. After a reaction time under pressure of estimated 10 minutes, the material can be taken out of the mold and should be stored for further 1 hour for final curing. After conducting the final test of material durability and safety, as stated in the operation and safety procedure and regulated through the environmental laws, the finished product can be used for its desired application.

### Mechanical and Safety Installation of the Process

1. Receiving, Loading and Leftover feeding Stations: The loading of the different and mostly pre-segregated leftovers and residuals in solid and liquid form on to the equipment and to the separated treatment systems, such as: the solid or solid and liquid leftovers/residuals, if not segregated to the shredder hopper (FIGS. 2+2a.−5, 6) and the liquid leftovers/residuals into the liquid blending station (FIGS. 2-12). The transport of the, in normally yellow bags, color coding for infectious and bio-hazardous waste, delivered and received leftovers/residuals from the receiving station, after their proper scaling and weight monitoring are accomplished using a closed lifter/elevator system (FIGS. 2+3+3a−2, 3, 29, 29a). The elevator system is connected on and equipped with the present safety installations.
2. Shredder Hopper and Shredder Station: The shredder hopper and shredder station (FIGS. 2+2a.−5, 6) is on itself closed operating system with multiple injection connection (FIGS. 2+2a−1, 2, 3, 9) for the injection of additives in liquid and gas form. The shredder material outlet is directly placed over the ribbon blender/mixer (FIGS. 2+2a−20) and the output size are controlled through an implemented and exchangeable output control screen. The shredder and shredder hopper are connected to the integrated air, dust, vapor and gas control system/wet scrubber (FIGS. 4-1, 3), powered through a static, in combination with a jet blower.
3. Liquid Leftover and Residuals blending Station: The liquid leftover and residual blending station (FIGS. 2-12) are connected on an integrated agitation and circulation system and to all additive/reagent supplies needed for the pre-neutralization of the liquid leftovers, before injecting them over an injection system (FIGS. 2+2a−9, 10, 11, 12) into the shredder hopper or into the ribbon blender (FIGS. 2+2a−20) directly. The decision, where the injection takes place is binding on the material pre-neutralized.
4. Ribbon Blender/Mixer Station: The ribbon blender/mixer station (FIGS. 2+2a−20) are the receiving station of the under reaction standing pre-prepared and/or pre-neutralized solid and liquid leftovers/residuals for final treatment, neutralization and conversion. The ribbon blender/mixer are connected to the additive/reagent injection station (FIGS. 1-3, 4, 5, 6, 24, 25) which are activated and controlled out of the operator and control room. The ribbon blender/mixer are connected to the integrated air, dust, vapor and gas control system/wet scrubber (FIGS. 4-1, 3), powered through a static, in combination with a jet blower.
5. Dry Additive Loading Station: The dry additive loading and distribution station (FIGS. 2+2a−4, 14) are a dual chamber silo type holding tanks and located over the ribbon blender/mixer. The dry/powder additive/reagent feeding are accomplished through electrical timer controlled screw conveyors (FIGS. 2+2a−14), which discharges the desired exact amount of additive. The loading of the dry additive/reagent silos can be made manually or using a conveyor system.
6. Discharge of treated, neutralized and sterilized Material: After adding the additives/reagents into the ribbon blender/mixer, based on the given injection sequence and the completed blending process, the sterilized and neutralized material will be discharged using a discharge screw conveyor (FIGS. 2-15). After the material is discharged, the further used of it as secondary raw material can be implemented.
7. Additive/Reagent blending Station: The additive/reagent blending station (FIGS. 1-1, 2, 10, 11, 12, 13, 14) are similar to the liquid leftover/residual blending station with its connection to the water supply, the wet scrubber system and to the additive/reagent holding tanks. There are two equal designed additive/reagent blending station to secure the separation of H₂O₂ from all other additives, especially FeCl₃. The additive/reagent H₂O₂ will be through the whole system separate and independently handled, with his own piping system, storage tank, blending- and injection system (FIGS. 1-3, 4, 5, 6, 24, 25).
8. Wet Scrubber System/Air Pollution Control System: The air pollution control system is designed on the wet scrubber Principle, which is activated through 2 blower units (FIGS. 4-1, 3). The wet scrubber basically works on under pressure, but this design will also operate safely during overpressure, generated maybe through an uncontrolled polymeric/radical/violent reaction and an unusual high generation of vapor or gas will occur. The wet scrubber system is connected to all major equipments, which are involved or containing ongoing chemical reactions and to equipments (lift/elevator) which are used for the internal transport and handling of untreated leftovers/residuals and to the different and from each other separated operator and processing chambers. The wet scrubber is in itself contained and circulating system. The wet scrubber has its own and integrated air and water/liquid reactivation and control systems. The four (4) chamber wet scrubber (FIGS. 4-5, 6, 7, 8, 12, 14, 15) is continuously supplied with ozone injection into the wet scrubber liquid, the circulated are passes over an air washing system, before entering the wet scrubber chamber. The air and continuous circulating wet scrubber water outlets are channeled over independent from each other operating infrared stations (FIGS. 4-9, 10). The air passes through an activated carbon filter station (FIGS. 4-4), before reentering in the system and the wet scrubber water are circulated back into the scrubber chamber.
8. General installed Safety Features: Beside the basic standard safety features on the electrical and mechanical installation, additional features were added, such as:
a. Pump and Circulation Systems: all pump systems (FIGS. 1+4−2, 13, 16) are connected with bypasses and with double function, if one pump has a break down, or need maintenance, the other pump will take over the function. Therefore main process interruptions are eliminated.
b. Emergency: The processing unit is equipped with an independent pressurized fresh water system (FIGS. 1+2−21, 22, 23), which are used to operate the emergency shower with integrated eye wash and full body showering installation and step on activated. At the same time the fresh water system functioning as emergency process/reaction shuts down, therefore the fresh water system is connected to all equipment parts/installation, where are chemical reaction ongoing.
c. Protection from Air pollution: To protect from and prevent airborne bacteria and microorganism, the system is additionally equipped with dark ultraviolet installation and anti-germ lights. The lights are placed in every room and chamber. The lights are normally not visible, about they are mounted between two ceilings (FIGS. 3a-1, 2, 7, 8) with separated maintenance openings and integrated airflow. In the operator room, the UV and anti-germ lights only activated during operation stop and minimum 1 hour before operation begins the lights are deactivated. Except in the processing compartments, in which is during operation no personnel allowed, the lights will be continuous activated.
d. Communication: Every room and chamber is connected to an intercom system to secure the proper communication during operation and maintenance.
e. Additional Controls: As additional controls are the visual flow direction control installation, the pH and process reaction temperature controls, visual control of additive level in the storage tanks and measurement tanks, visual and pH control on the wet scrubber with integrated color coding to estimate in which time the wet scrubber liquid need to changed/replaced. The replaced wet scrubber liquid will be placed into a process rest water tank and reuse in and during the continuous treatment process as fresh water replacement. The incoming materials are inspected and tested of radiation and bigger present metals, beside the standardized receiving procedure.
d. Operator Safety: The whole operation is color coded and only personnel with the corresponding color I. D. can enter those areas. Beside the internal Safety Rules and Regulation, the personnel need to undergo regularly process related and safety trainings. Health Care Passports are issued to the personnel. This Passports indicates all the personal Data of the Employee, his training and the general health condition, beside the medical data and when the last medical check up was and when will be the next medical check up conducted.

### BRIEF DESCRIPTION OF THE DRAWINGS AND APPENDIX

FIG. 1 Mobile Unit Schematic/Layout of the Cross Section and additive/reagent flow chart of the Pilot Plant as build and let show especially the liquid additive/reagent loading, blending, storage and injection amount measurement installations/station.

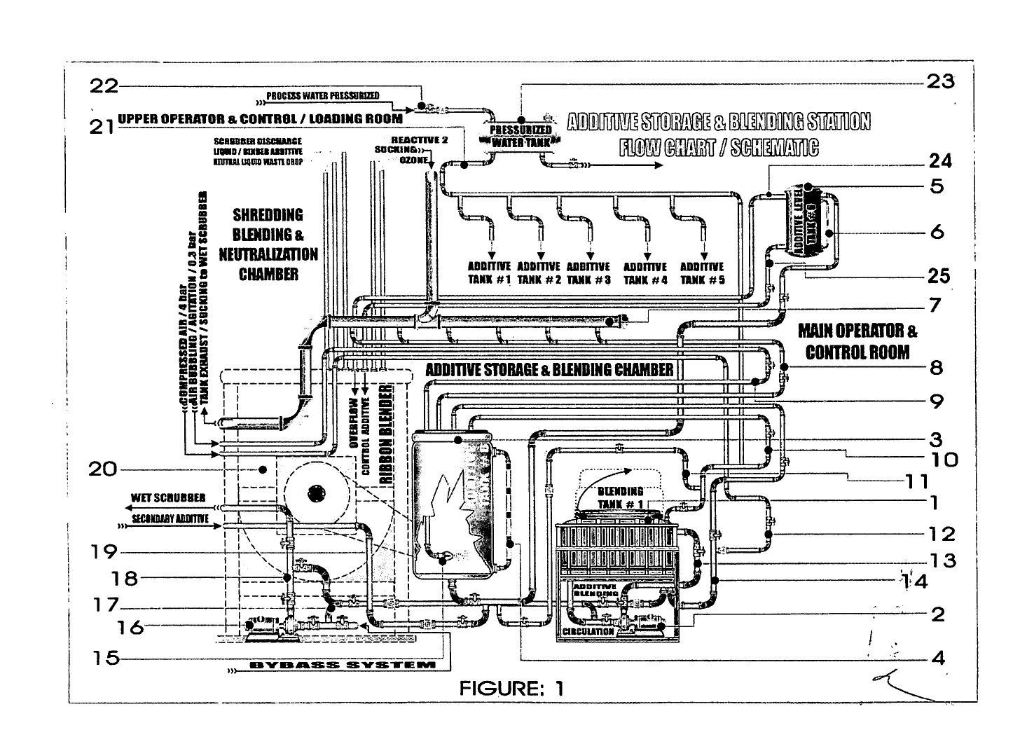

FIG. 2 Mobile Unit Schematic/Layout of the Cross Section and additive/reagent and solid leftovers/residuals flow chart of the Pilot Plant as build and let show especially the lifter—solid waste feeding station, liquid, gas and solid stations, such as: liquid and gas injection stations, solid residuals deformation shredder station with integrated hopper and the direct under it connected ribbon blender/mixer station and the dry additive/reagent storage with feeding system to the ribbon blender/mixer, including the special additive blending station for the additive blending to process the light radiation contaminated leftovers/residuals.

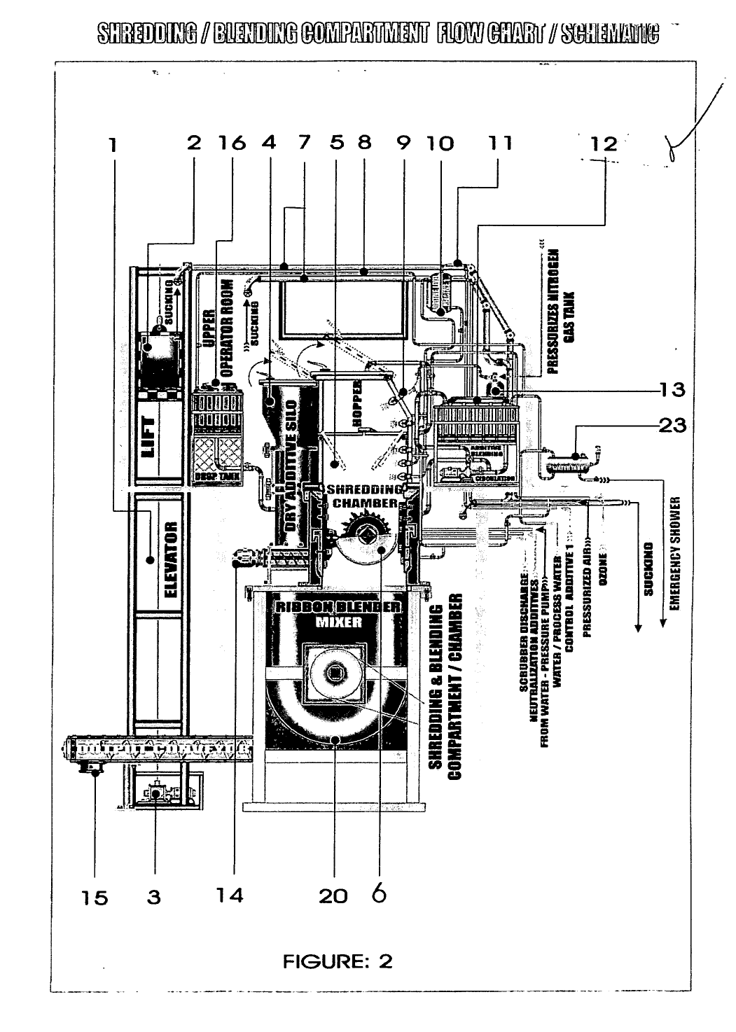

FIG. 2a Mobile Unit Schematic/Layout of the Cross Section and material flow chart of the Pilot Plant as build and let show especially the upper operator room.

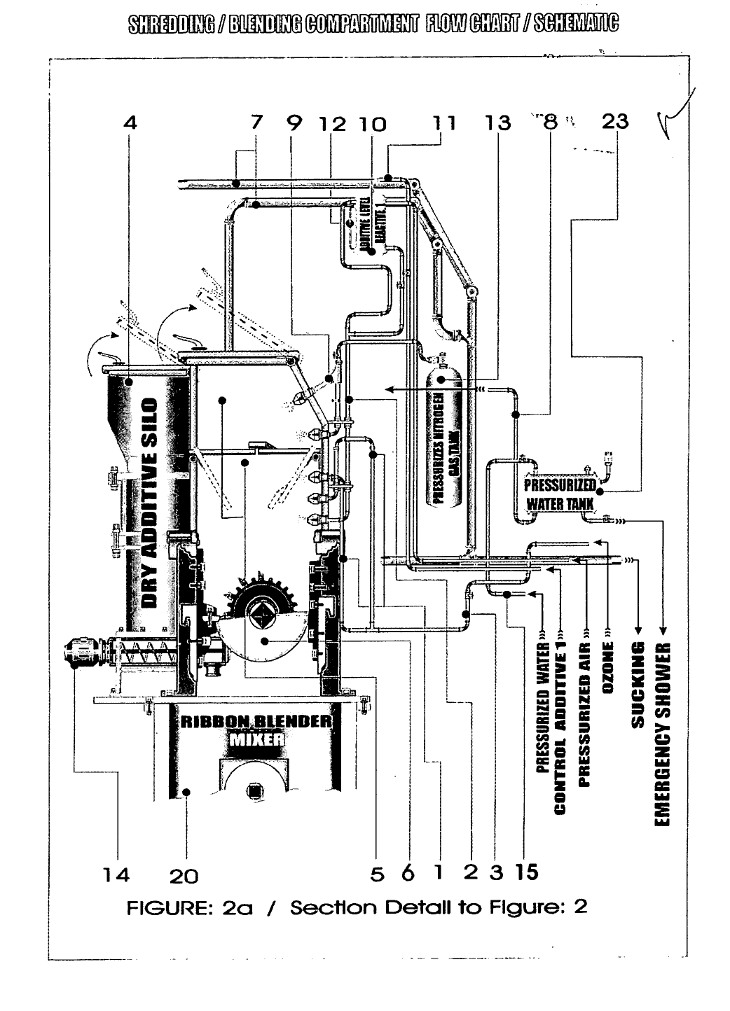

FIG. 3 Mobile Unit Schematic/Layout of the Cross Section and liquid additives/reagents and solid leftovers/residuals material flow chart of an automatic and totally enclosed operating system, based on the European standard with a continuous process flow. Therefore a dual ribbon blender/mixer system is designed into the basic installation.

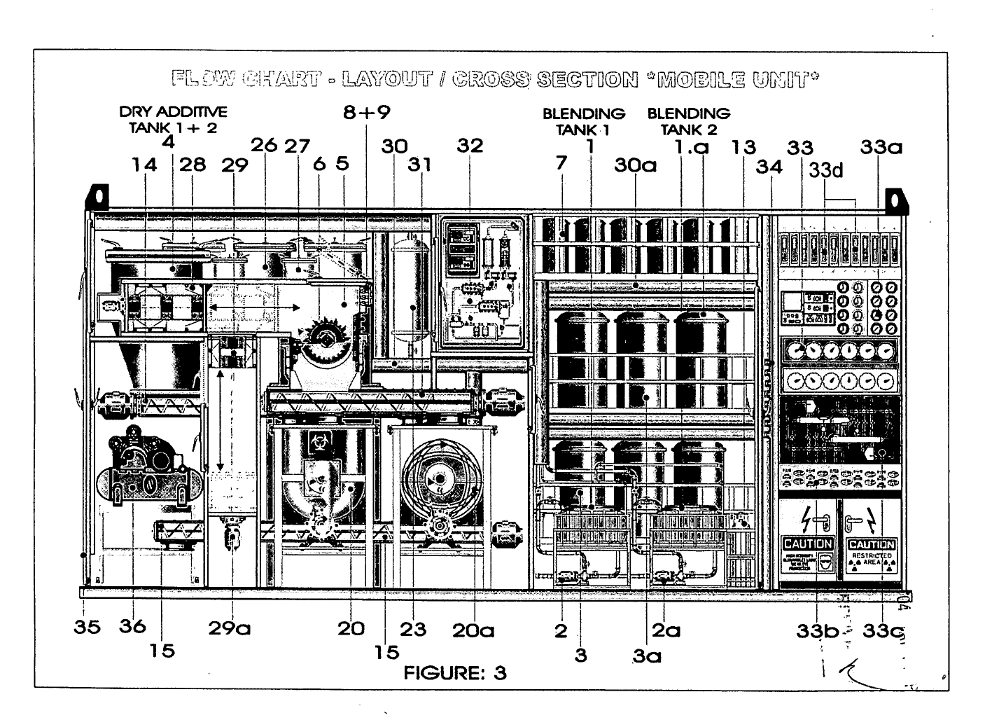

FIG. 3a Mobile Unit Schematic/Layout of the Cross Section (Square to the main equipment axis, rear end portion) and material flow chart of the solid leftovers/residuals material flow chart, of an automatic and totally enclosed operating system, based on the European standard with a continuous process flow.

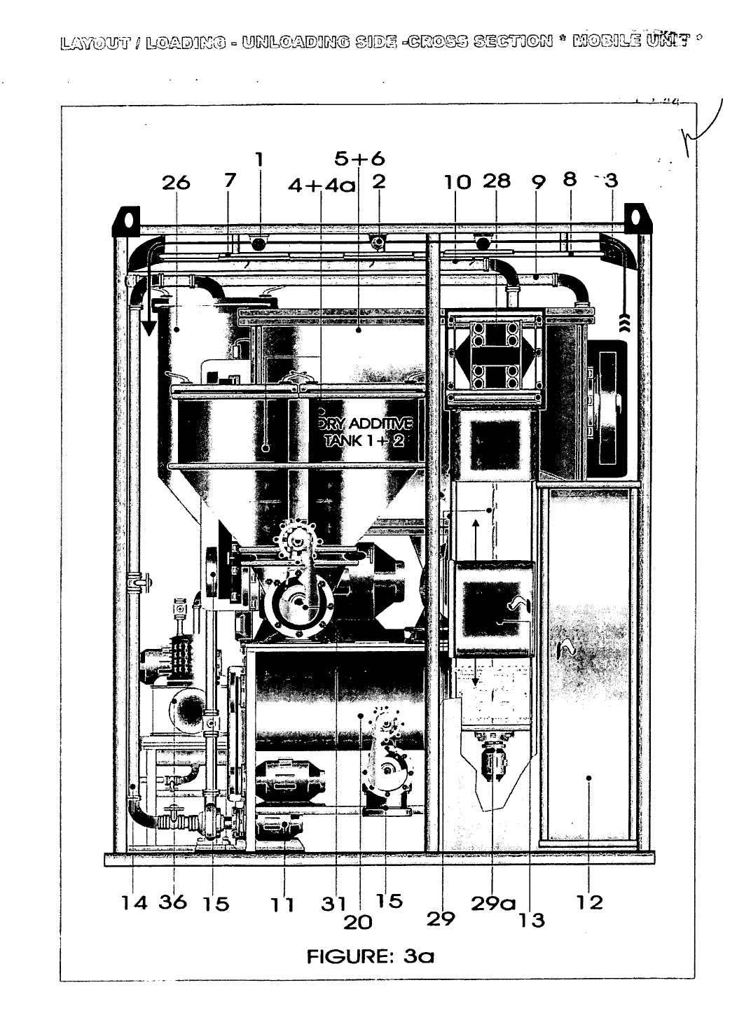

FIG. 4 Mobile Unit Schematic/Layout of the Cross Section of the air and wet scrubber liquid flow chart of the Pilot Plant as build. The schematic/flow chart let show the operation flow of the entire wet scrubber system including the air washing injection, the bubbling system, the O₃ injection and the air/water—scrubber liquid reactivation using UV and Infrared re-activators.

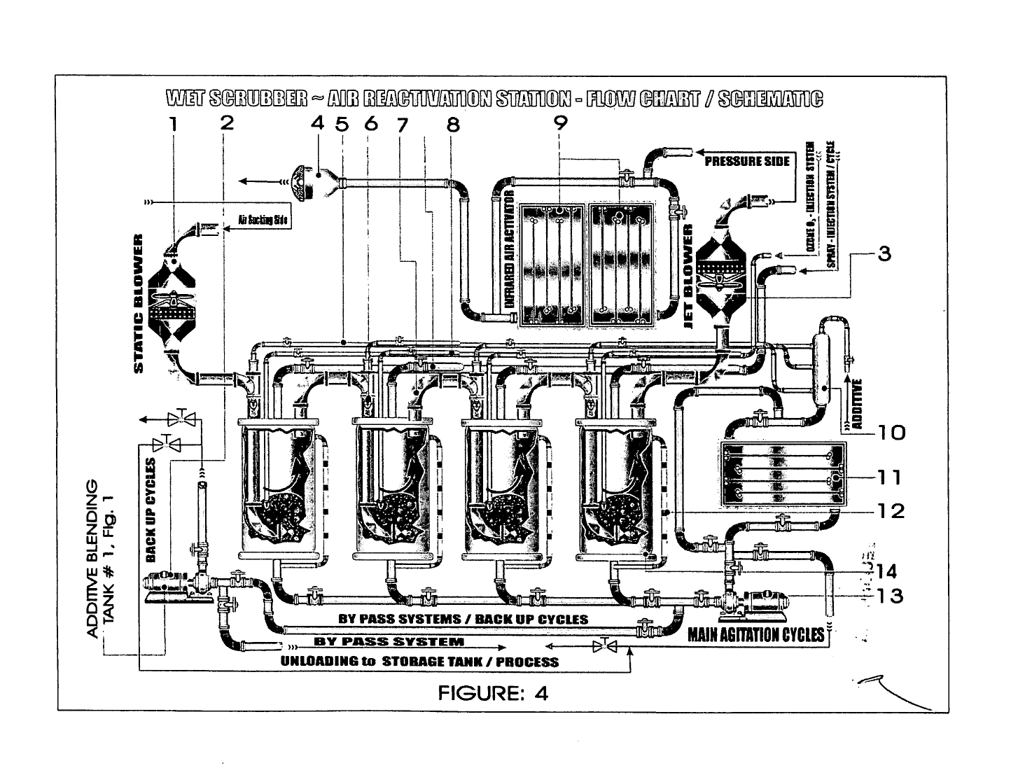

FIG. 5 Stationary operation Schematic Layout of the Cross Section and handling/processing steps of liquid and solid material/additives flow chart with integrated leftovers/residuals receiving facility, which includes the implementation of specified transport containers and container service and handling stations.

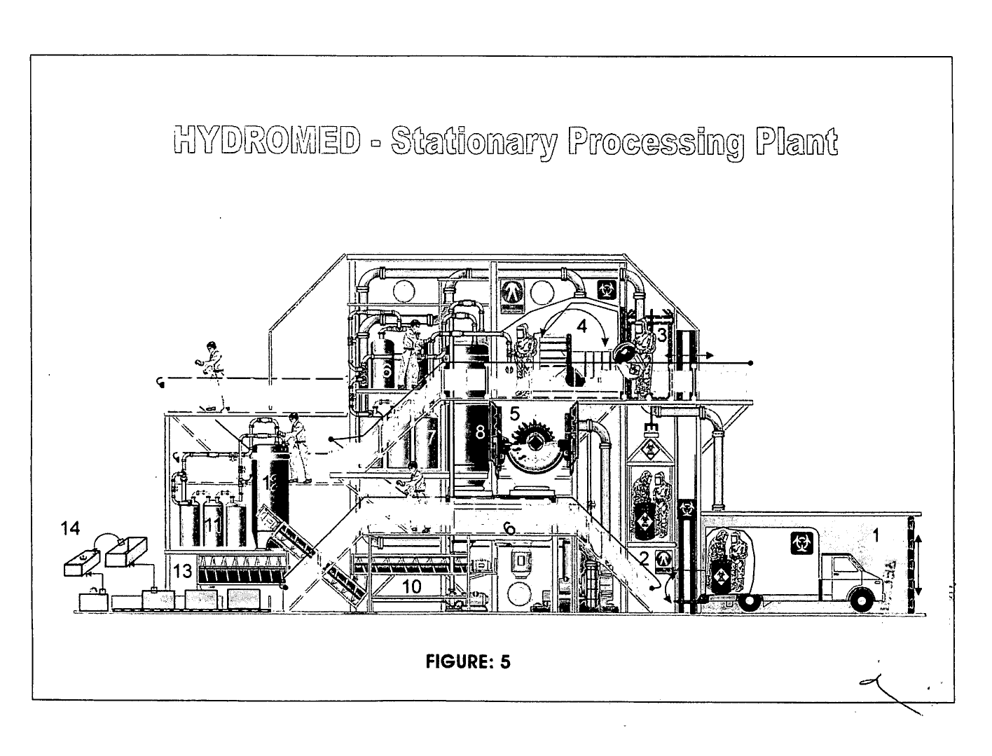

FIG. 5a Stationary operation Schematic/Layout and flow chart of process steps including rough process steps descriptions.

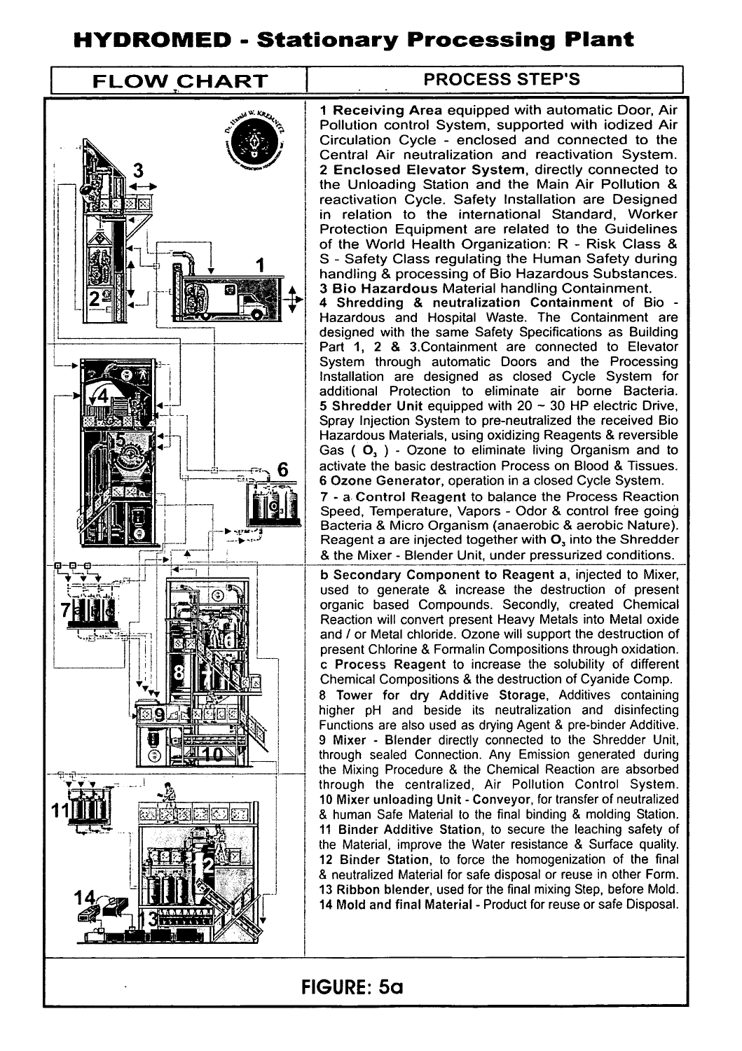

FIG. 5b Stationary operation Schematic/Layout and flow chart of process steps in relation to the operator, human and environmental safety including rough descriptions of the implemented safety installations and its functions.

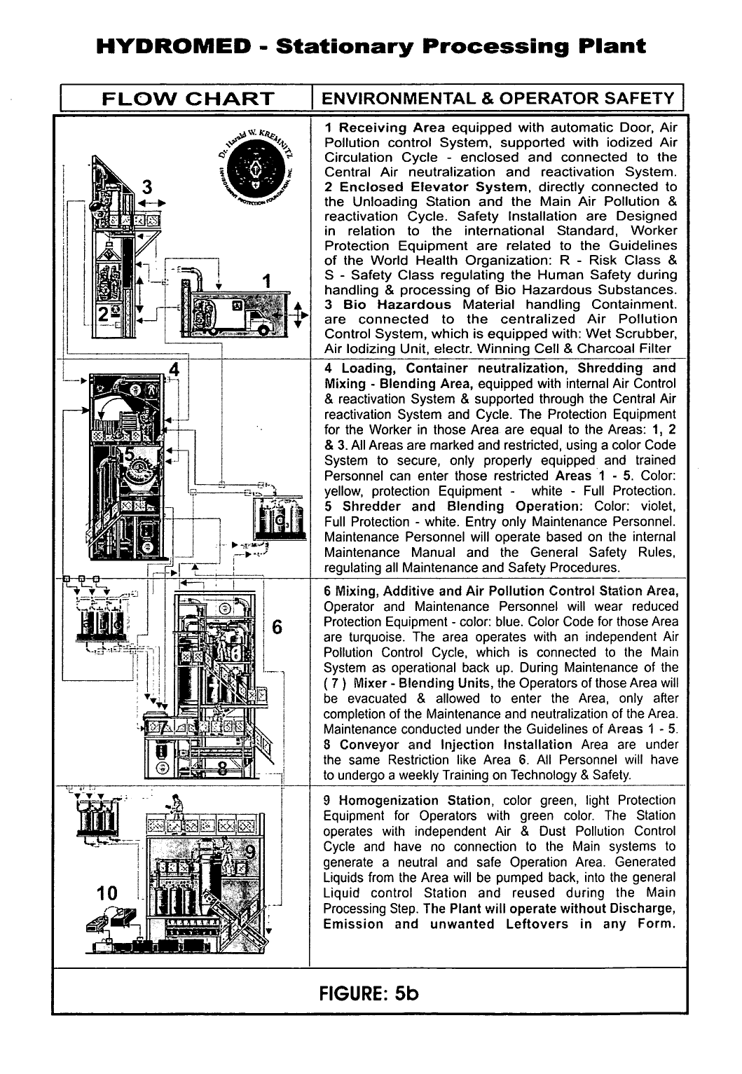

FIG. 5c Design and description of the handling and storage container system, to be used in the integrated in the collection, transport and leftovers/residuals receiving facility. The external collection and transport strategy can only operate safely if the logistic includes the implementation of specified transport containers and container service and handling stations.

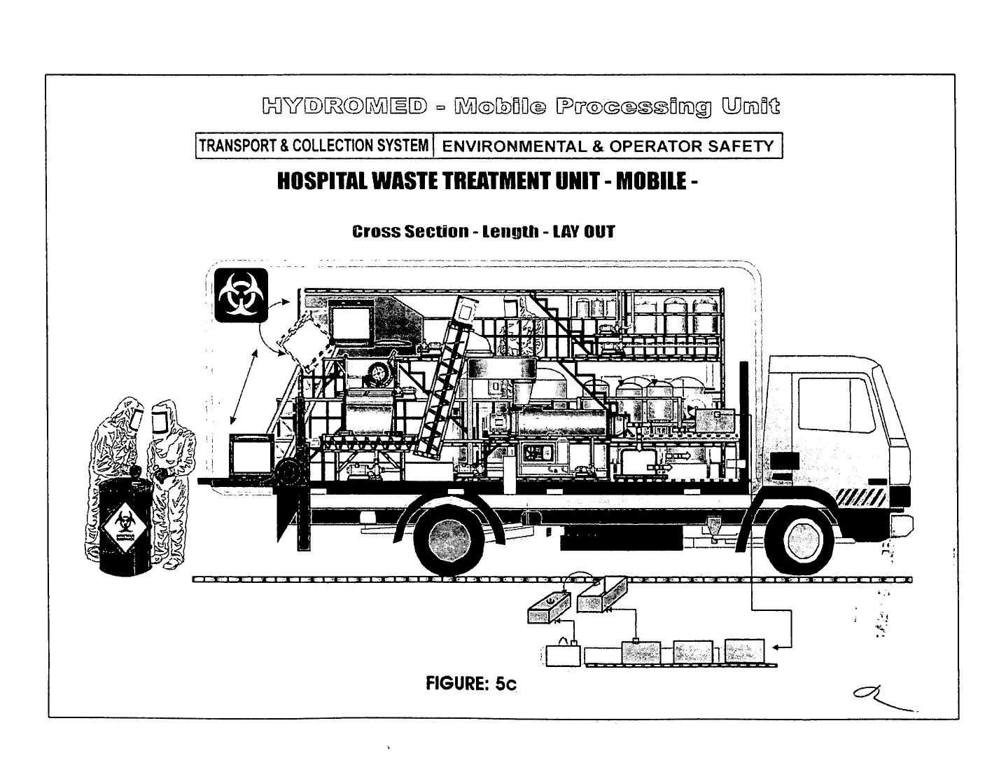

FIG. 6 Truck mounted/Mobile Facility/Unit with fully enclosed Containment. The Drawing let show the operation/process/material flow Schematic/Layout and the Flow Chart of process steps in relation to the operator, human and environmental safety and the standard product form.

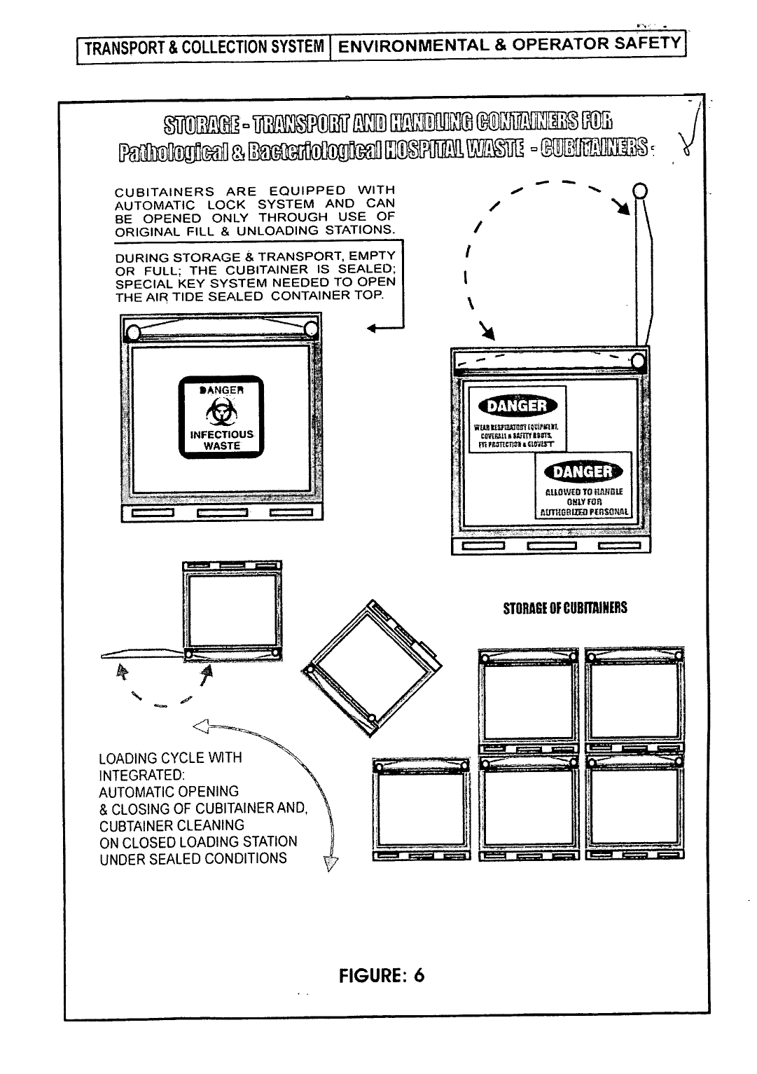

FIG. 7 Graphical Explanation—generalized mode of Wave-Counter Wave generation and Immobilization/Encapsulation in a Polymer Matrix to reduce—eliminate, based on empirical Tests, the Radiation Concentration and/or shorten the Half-Life Time of such slight radiation contaminated Materials and Substances.

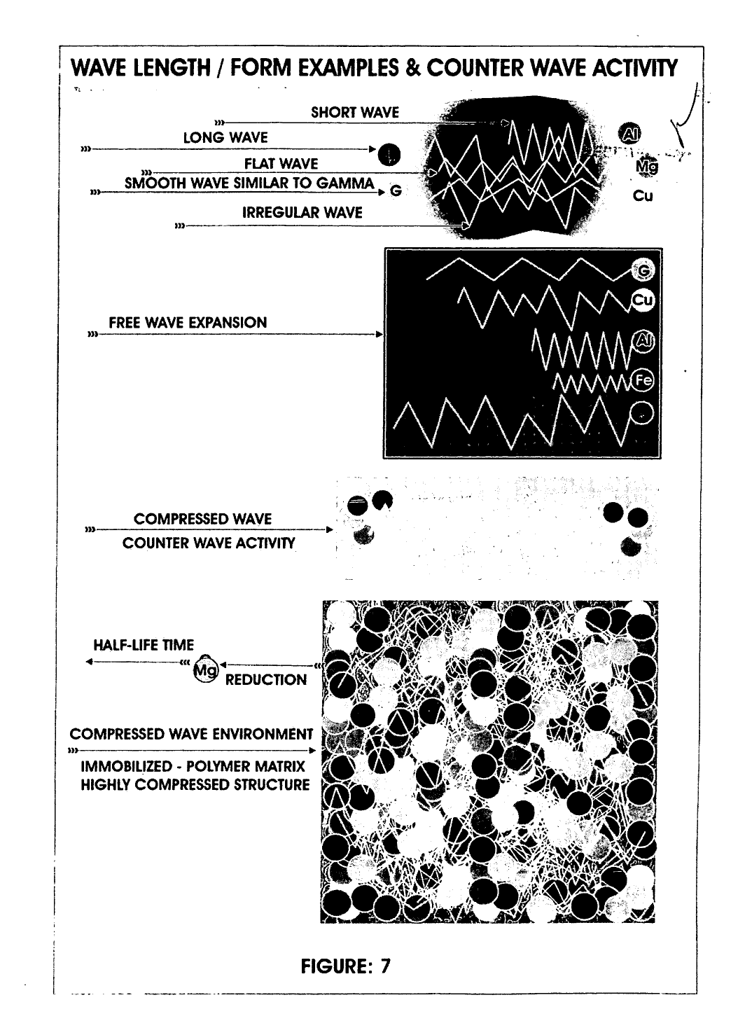

FIG. Appendix: 1. Summary of Laboratory Test Results, generated out of the material, processed on the, in pictures and drawing, shown pilot plant. The Laboratory results revealing test results and analysis's regarding the process performance on: sterilization effect—destruction of microorganism and bacteria, radiation reduction and elimination, TCLP performance of the final generated secondary raw material and the physical material performance regarding stability, density, heat resistance and long-term behavior under normal environmental conditions and influence.

FIG. Appendix: 2. Picture and Photo documentation of an operating pilot plant.

FIG. Appendix: 2.a. Plant attached to a larger hospital operation and implemented in permanent leftovers and residual treatment and neutralization operation for the final system and process performance.

FIG. Appendix: 2.b. Picture documentation of test operation, regarding the adding of different inoculums, such as: Bacillus Stearothermophilus—highly heat resistant spore/microorganism and Bacillus Subtilis—oxidation resistant spore/microorganism in addition to the present, not known contamination of the to neutralizing leftovers/residuals. Those tests are required by the United States of America—Environmental Protection Agency (US-E.P.A.) and the European Commission of Environmental Protection Association (E.L.I.S.A.) to secure a safe process—neutralization and sterilization performance, regardless the basic present contamination.

FIG. Appendix: 2.c. Picture documentation of the function of the visualized metal liquefying capability of the process and the different product types generated out of the neutralized and sterilized secondary raw material.

FIG. Appendix: 2.d. Picture documentation, visualizing the procedure of the conducted product test, regarding the physical performance of the products made out of the generated materials.

FIG. Appendix: 3.-3c. Summary/Examples of ongoing basic Chemical Reactions. Remark: The documentations let show at the same time, for the development and evaluation of the function, the operator and environmental safety of the process and durability, long-term safety and performance quality of the generated secondary material for safe and non-restricted disposal, a time frame of more than seven (7) years was involved.

1. A multifunctional, non-burn and non-steam or wave generation involving sterilization, neutralization and conversion process to handle, eliminate and process infectious, bio-hazardous, toxic and hazardous components, light radiation contaminated materials and components, leftovers and residuals in different hazardous levels, generated by Clinics, Dental Clinics, Hospitals, Biological Laboratories, Pharmaceutical and Chemical and to its related Industries with leftovers and residuals such as Fluids and Drugs, Narcotics, Bio-hazardous Waste in general, Microorganisms and Cultures, Form Cells, Insecticides, Pesticides, Prions (PrP, BSE)—Mad Cow Disease and otherwise contaminated Slaughter House Waste, beside infectious and cross contaminated fecal matters and sludge's, septic tank sludge's in general and materials, substances contaminated with heavy metal contamination and therefore the process has to operate human and environmentally safe, which was the guideline for the process design and the additive and reaction formulation to secure the entire process has no leftovers in any form, such as residuals, emission, odor and discharge which is mainly accomplished through the basic process reaction characteristic of oxidation, solid material destruction, remediation, oxidation and degrading of present organic components, the liquefying and leaching of heavy metals and its conversion into metal oxide and metal nitrate, the increase of the chemical attackable surface and volume decrease of the solid residuals using a combination of shredding and ripping mechanic to generate fibrous particles and increase the inorganic material surface destruction and an ongoing tree step polymerization, which additionally initiated through the chosen chemical additive composition and its blending sequence beside the corresponding reactive behavior of the remaining residuals enhanced and accelerated through the quick and multiple pH change from acidic to alkaline and ending the process in a slight alkaline condition and therefore, supported through the additives and the main residuals composition the generation of zero dimensional crystals and zeolite like structures takes place, beside the establishment of a low grade and cross linked polymer matrix formation with medium and long chain under the implementation and embedding of remaining and free going reactive and non-reactive organic and inorganic compounds, which secure an inert like substance without immobilization of any substances, residuals considered as toxic and hazardous and risk free reusable as secondary raw material will remain after the multilevel reaction procedure and final processing step.

2. A method according to claim 1, the said chemical reaction, partially leaching and liquefying of heavy metals and other present metal forms and of converting it into metal oxide, nitrate and sulfate, by using the same basic additives and process equipment for the treatment of slight and or light radiation waste, generated out of different sources from laboratories, health care institutions, and the industry, the only restriction, this process step and procedure has to be conducted strictly independent from all other materials to avoid the possibility of cross contamination with non-radiation influenced residuals and through the inoculation of strong wave generating metal based additives and substances to be blended into the processing step of metal transformation, using an additional additive mixture of I₂+Cu₂SO₄+MgSO₄7 (H2O)+MgO+Fe₂O₃+Cu₂O which is activating under the present ongoing basic reaction the extended ion exchange and producing the, based on the metal type single or multiple cation charge, therefore a cross linkage between positive and negative charges are established and the metal molecules dispersing tight under each other with its own different wave forms, therefore the free reacting mass has to be immobilized in a tight polymer matrix to secure high density homogenization and the reduction, elimination of the movement of the molecular structure, which result in the interference of the different waves generated and the base of the counter wave reaction is established, with the result of temperature increase of the binder material as result of the shortage like and overlapping counter wave, behavior and the result of those generated reduction are the reduction and/or elimination of radiation emission, pollution.

3. A method according to claim 1 and 2, the said generation of zero dimensional crystals structures and zeolite like formations, which is one of the important reaction to support positively the ongoing structuring and creation of the base for a low grade and cross linked polymer matrix formation generates and supports the chemical and reactive fundament for the implementation of an economical and high on quality, cross linked, for the process important, slow reacting polymer matrix, using only one the polyole component and replacing the, costly and considered as harmful Isocyanate components including the reaction speed and material expansion control additive ammonium chloride, with a very efficient and low cost mixture out of water with sugar and rubbing alcohol (H₂O+C₆H₁₂O₆+C₃H₇OH), which is the basic component for a tight and high density polymer matrix, necessary for the, with and under pressure supported homogenization to guarantee the of the pre-treated and pre-neutralized former light radiation contaminated materials forming into a closed molecular structure with the blended additional additives, which generating the counter waves to reduce the half-life time of the radiation, or their total elimination.

4. A method according to claim 1 and 2, the said process can handle liquid and solid, slight radiation contaminated residuals including metal containing leftovers, such as Heart-Lung and Dialysis Equipment filter and filter inlets, mostly composed out of metal and ceramic screens, needles, sharps and other materials related to it, beside residuals made out of cotton—synthetic and other sources of fibers, rubber and plastic based components, including leftovers generated through cancer—chemotherapies and other residuals of pharmaceutical origin including medical laboratory waste in form of substances and solids, such as blood container, xylene, benzene, toluene, expired medicines, tissues and from the operating rooms the surgery waste in general including body parts and infected residuals, beside the hospital personnel's protection gadgets.

5. A method according to claim 1, 2 and 4, the generation of a highly reactive, oxidative, chemical remediation like environment, which eliminates the survival rate of any living organism and severe destructive to all present organic components and compounds which eliminates beside all organism also organic based components, considered as toxic and hazardous, forces blood and blood plasma related substances to coagulated immediately and destruct tissues, this chemical reaction is supported through a mechanical shredding like ripping, solid material destruction technique which guarantees, based on the design a controlled desired largest particle output size, therefore the combination between chemical reaction and mechanical support in form of increase of the, from the chemical easier attackable surface, the controlled output, the chemical reaction increases through the additional temperature enhancement, as a result of the mechanical force on the solid materials during the destruction process a chemical—physical reaction is established which resolves in a sterile material output without the possibility of recognizing the material origin.

6. A method according to claim 5, the said process generate a material output characteristic and consistency in form and safety, the material can be compared, based to the laboratory test results as, sterile material with inert like character and suitable for the use as a secondary raw material for second class applications, which supports the use of normal cement, bentonite, lime, sodium bentionite, grout binder, different adhesives, resin binders, or cement like binders to homogenize those materials into one of the 24 tested products, without the image of possible immobilization of, to matters and components, considered as toxic and hazardous.

7. A method according to claim 1 to 6, the said process uses no additives which are restricted, or not widely available and not one additive used in the said process is as concentrate higher in the toxicity and hazardous level as the leftovers and residual to be neutralize and converted, beside not one of the reagents and additives in its highly diluted form, is presenting or generating direct or indirect hazards to the operator and to the surrounding environment.

8. A method according to claim 7, the said process and equipment are designed as closed system without any unusable leftovers, no discharge and no emission provision, the air in the closed containment is reactivated and re-circulated through the air pollution control system, supported through air ozonization and ionization and continuous operating dual blower activated wet scrubber system and separate control and air cleanup operation of the containment air and the operation equipment air and gas mixtures, at the same time if the wet scrubber liquid has to be replaced, it will be internally stored and reused as process water replacement, which is an additional advantage to the whole process about the permanent shortage of liquid substances and normal water has to be used.

9. A method according to claim 1, 2, 3, 5 the said process with his reaction characteristic of chemical, in combination with bio-chemical remediation, which reduces and eliminates beside different other present organic matters and components also potentially proteins, enzymes, co-enzymes and organic nitrogen—nitrogen and its components in general and therefore the basic substance of protein and nitrogen, considered as the host and feeding ground for (PrP+BSE, etc.) prion protein, mostly found in animal brain and bone marrow, which is the source, causing the spread disease of mad cow disease, and other to its related diseases, resulting mostly in human and animal brain damages and ending with human fatalities, therefore the source, host, has to be eliminated, reduced and the virus contained to decrease the multiplication and spread activity of this very stable spongy form, therefore this process is designed to generate a chemical reaction sequence and type of polymer matrix which not only destruct, encapsulate and immobilize the host and the organism, using also both as part of the cross linked polymer chain creation, as basic for the later under pressure formed high density polymer matrix with excellent resistant properties towards ultraviolet and infrared influence, organic and inorganic components in alkaline and acidic conditions, fire resistant, water repellant, highly load bearing, dense molecular structure and not attacked and host to any form of microorganism, based on the material characteristic and consistence, to secure a proper isolation of the prion's and to its related or similar organism, which can remain over forty (40) years inactive even by very low and high temperature and resistant to different light waves, and the possibility of reactivation are ever present.
